(19) United States
(12) Patent Application Publication
(10) Pub. No.: US 2026/0367566 A1
(43) Pub. Date: Nov. 19, 2026

(54) IMAGE FORMING SYSTEM AND SHEET FEEDING APPARATUS

(71) Applicant: CANON KABUSHIKI KAISHA, Tokyo (JP)

(72) Inventor: HIROSHIGE INOUE, Tokyo (JP)

(21) Appl. No.: 19/669,174

(22) Filed: May 6, 2026

(30) Foreign Application Priority Data
May 14, 2025 (JP) 2025-081045

(51) Int. Cl. G03G 15/00

(52) U.S. Cl. CPC G03G 15/6567; G03G 15/50; G03G 15/6502; G03G 2215/00561; G03G 2215/00679; G03G 2215/00721

(57) ABSTRACT

An image forming system includes an image forming apparatus including an image forming unit for forming an image on a sheet, a first sheet feeding apparatus coupled to the image forming apparatus, a second sheet feeding apparatus coupled to the first sheet feeding apparatus, a first correction unit disposed on the first conveyance path for correcting a widthwise position of the sheet by moving the sheet in a width direction orthogonal to the sheet conveyance direction, a second correction unit disposed upstream of the first conveyance path and downstream of the second feeding unit for correcting the widthwise position of the sheet by moving the sheet in the width direction, and a control unit configured to correct the widthwise position of the sheet fed from the second feeding unit by one of the first correction unit and the second correction unit and feed the corrected sheet to the image forming apparatus.

### BACKGROUND

### Field of the Technology

The present disclosure relates to an image forming system that conveys a sheet, and a sheet feeding apparatus.

### Description of the Related Art

For example, in an image forming system that prints products such as bound books and catalogs, it is required to use a plurality of sheets of different types and sizes, and it is required to store a large volume of sheets in order to improve productivity. Therefore, an image forming system in which a multistage feeding apparatus and a feeding deck are coupled to an image forming apparatus has been proposed (see JP 2021-107280 A).

### SUMMARY

By the way, it is possible to achieve proper alignment for image formation with respect to the sheet by performing correction processing of correcting the posture and position of the sheet in an apparatus coupled at a position upstream of the image forming apparatus in a sheet conveyance direction as in the multistage feeding apparatus in JP 2021-107280 A. However, productivity may decrease in a case where the number of executions of the correction processing is large in a configuration in which a plurality of apparatuses are coupled.

According to a first aspect of the present disclosure, an image forming system includes an image forming apparatus including an image forming unit configured to form an image on a sheet, a first sheet feeding apparatus coupled to the image forming apparatus at a position upstream of the image forming apparatus in a sheet conveyance direction and including a first feeding unit configured to feed the sheet, a first conveyance path through which the sheet fed from the first feeding unit is conveyed toward the image forming apparatus, and a third conveyance path connected to the first conveyance path, a second sheet feeding apparatus coupled to the first sheet feeding apparatus at a position upstream of the first sheet feeding apparatus in the sheet conveyance direction and including a second feeding unit configured to feed the sheet and a second conveyance path through which the sheet fed from the second feeding unit is conveyed toward the third conveyance path, a first correction unit disposed on the first conveyance path and configured to correct a widthwise position of the sheet by moving the sheet in a width direction orthogonal to the sheet conveyance direction, a second correction unit disposed upstream of the first conveyance path and downstream of the second feeding unit and configured to correct the widthwise position of the sheet by moving the sheet in the width direction, and a control unit configured to correct the widthwise position of the sheet fed from the second feeding unit by one of the first correction unit and the second correction unit and feed the corrected sheet to the image forming apparatus.

According to a second aspect of the present disclosure, a sheet feeding apparatus including a first sheet feeding apparatus and a second sheet feeding apparatus that is coupled to the first sheet feeding apparatus at a position upstream of the first sheet feeding apparatus in a sheet conveyance direction, the sheet feeding apparatus including: a first feeding unit disposed in the first sheet feeding apparatus and configured to feed a sheet toward a first conveyance path, a second feeding unit disposed in the second sheet feeding apparatus and configured to feed the sheet toward a second conveyance path, a first correction unit disposed on the first conveyance path and configured to correct a widthwise position of the sheet by moving the sheet in a width direction orthogonal to the sheet conveyance direction, a second correction unit disposed upstream of the first conveyance path and downstream of the second feeding unit and configured to correct the widthwise position of the sheet by moving the sheet in the width direction, and a control unit configured to correct, by the first correction unit or the second correction unit, the widthwise position of the sheet conveyed from a position upstream of the second correction unit in the sheet conveyance direction.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating an image forming system according to a first embodiment.

FIG. 2 is a top view illustrating a relay conveyance device according to the first embodiment.

FIG. 3 is a block diagram illustrating a control system of the image forming system according to the first embodiment.

FIG. 4 is a flowchart illustrating sheet conveyance control in the image forming system according to the first embodiment.

FIG. 5 is a schematic view illustrating configurations of a first registration unit and a second registration unit according to the first embodiment.

FIG. 6 is a schematic view illustrating configurations of a first registration unit, a first sheet feeding apparatus, and a second sheet feeding apparatus according to the first embodiment.

FIG. 7 is a schematic view illustrating an image forming system according to a second embodiment.

FIG. 8 is a schematic view illustrating configurations of a first registration unit, a first sheet feeding apparatus, a long-sheet feeding apparatus, and a manual feeding apparatus according to the second embodiment.

### DESCRIPTION OF THE EMBODIMENTS

### First Embodiment

Hereinafter, a first embodiment according to the present disclosure will be described with reference to the drawings.

### Image Forming System

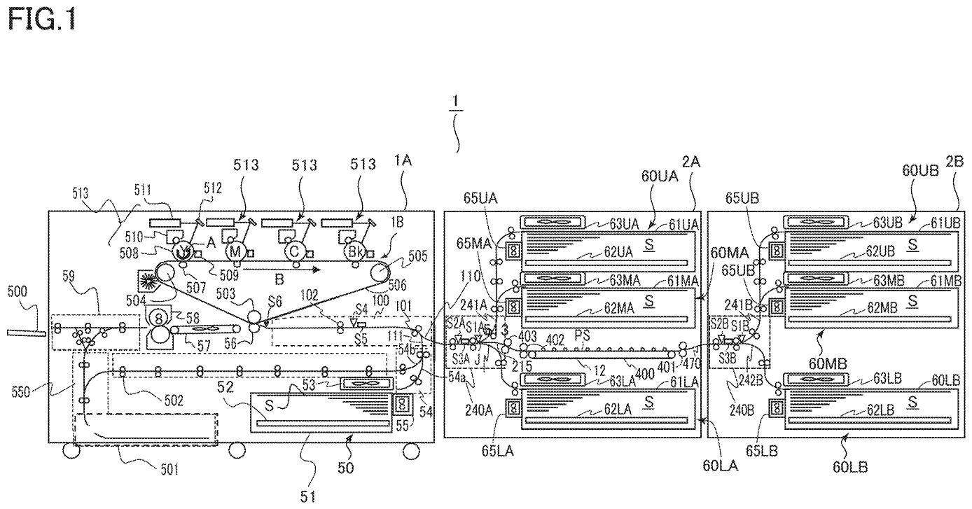

First, an overall configuration of an image forming system 1 according to a first embodiment will be described. FIG. 1 is a schematic view illustrating the image forming system according to the first embodiment. The image forming system 1 includes an image forming apparatus 1A, a downstream deck 2A serving as a first sheet feeding apparatus or a sheet feeding apparatus coupled to the image forming apparatus 1A at a position upstream in a sheet conveyance direction, and an upstream deck 2B serving as a second sheet feeding apparatus coupled to the downstream deck 2A at a position upstream in the sheet conveyance direction.

The image forming system 1 forms an image on a sheet S by using an image forming unit 1B while conveying the sheet S one by one. As the sheet serving as a recording material (recording medium), various sheet materials having different sizes and materials, for example, paper such as plain paper or thick paper, a sheet material subjected to surface treatment such as coated paper, a sheet material having a special shape such as an envelope or index paper, a plastic film, and cloth, can be used.

### Image Forming Apparatus

First, the image forming apparatus 1A according to the first embodiment will be described. The image forming apparatus 1A includes the tandem intermediate transfer type image forming unit 1B in which four process units 513 are arranged along an intermediate transfer belt 506 serving as an intermediate transfer member. As compared with a direct transfer type, the intermediate transfer type does not need to hold the sheet S on a transfer drum or a transfer belt, and thus has an advantage of easily handling various sheets S such as super thick paper and coated paper. In addition, the tandem intermediate transfer type is suitable for achieving high productivity because of characteristic like parallel processing in the plurality of process units 513 and collective transfer of a full-color image formed by superimposing toner images of a plurality of colors.

The image forming unit 1B is an example of an image forming unit that forms an image on the sheet S, and a direct transfer type electrophotographic unit in which a toner image formed on a photosensitive drum 508 is transferred to the sheet S without passing through the intermediate transfer member may also be used as the image forming unit 1B. The image forming unit is not limited to the electrophotographic type, and may be, for example, an inkjet printing unit.

Each process unit 513 includes the photosensitive drum 508 serving as an image bearing member, a charging device, an exposure device 511, a developing device 510, and a cleaning device 509. The intermediate transfer belt 506 is stretched around a driving roller 504, a tension roller 505, and an secondary transfer inner roller 503, and is conveyed by being driven in a direction B indicated by an arrow in the figure. A primary transfer roller 507 is disposed on an inner peripheral side of the intermediate transfer belt 506 at a position corresponding to each photosensitive drum 508. A secondary transfer roller 56 is disposed on an outer peripheral side of the intermediate transfer belt 506 at a position facing the secondary transfer inner roller 503 with the intermediate transfer belt 506 interposed therebetween.

The image forming apparatus 1A further includes a sheet feeding unit 50, a pre-registration conveyance unit 54, and a third registration unit 100 serving as a third correction unit. Further, the image forming apparatus 1A includes a pre-fixing conveyance unit 57, a fixing device 58, a branch conveyance unit 59, a reverse discharge unit 550, a duplex reversing unit 501, and a duplex conveyance unit 502.

A flow of an image forming operation will be described. Here, it is assumed that the sheet S is fed from the sheet feeding unit 50 in a main body.

The sheet feeding unit 50 includes a storage 51 which is a so-called cassette and a lift plate 52 which supports the sheets. The sheet feeding unit 50 further includes an air separation unit 55 that blows air to the sheets supported by the lift plate 52 to separate the sheets, and an air feeding unit 53 that feeds the sheet separated by the air by air suction. The sheet S in the storage 51 is stored in a state of being supported on the lift plate 52, and is lifted and lowered by a lift-up device (not shown). The air separation unit 55 separates several uppermost sheets S in the storage 51 by blowing high-pressure air toward upstream edges in the sheet conveyance direction, and the sheets S are fed one by one by the air feeding unit 53 according to an operation timing of the image forming unit 1B. A sheet feeding method includes an air suction method of sucking the sheet S to the belt by a negative pressure generated by a fan and conveying the sheet S, and a roller method of using a frictional force of a roller rotating by abutting against the sheet S. The air feeding unit 53 in FIG. 1 is of the air suction method. The sheet S fed by the air feeding unit 53 passes through the pre-registration conveyance unit 54 and is conveyed from a conveyance path 111 to the third registration unit 100.

The third registration unit 100 includes a third pre-registration sensor S4 that detects a leading edge of the sheet S, and a third line sensor S5 that detects an edge portion (hereinafter, referred to as a “side edge”) of the sheet S in a width direction. Further, a third pre-registration roller pair 101 and a third registration roller pair 102 are disposed in the third registration unit 100. The third line sensor S5 is implemented by a contact image sensor or the like, and detects a position of the side edge of the sheet S from a detected image. Rotation of the third registration roller pair 102 is stopped after the preceding sheet S has passed, and when the leading edge of the sheet S abuts against the third registration roller pair 102 in a stopped state, the sheet S buckles and the leading edge of the sheet S is caused to follow the third registration roller pair 102, so that skew is corrected. Then, the third registration roller pair 102 starts the rotation at a timing when a predetermined amount of buckling is formed in the sheet S based on a timing when the leading edge of the sheet S is detected by the third pre-registration sensor S4, and conveys the sheet S. Further, the third registration roller pair 102 is configured to be movable (shiftable) in the width direction by a shifting mechanism and a shifting motor (not shown), and performs lateral registration correction of a position of the sheet S in the width direction based on a detection result of the third line sensor S5 in a state of nipping the sheet S.

In the present specification, the lateral registration correction includes both correction of the position of the sheet in the width direction with respect to a position where the image is to be formed on the sheet by the image forming unit 1B and correction of the position where the image is to be formed with respect to the position of the sheet in the width direction in the image forming unit 1B. However, the lateral registration correction here refers to the correction of the position of the sheet in the width direction using the third registration roller pair 102.

A post-registration sensor S6 that detects the leading edge of the sheet S is disposed downstream of the third registration unit 100 in the sheet conveyance direction. The third registration roller pair 102 measures a delay time of the sheet S with respect to a reference conveyance timing based on a detection result of the post-registration sensor S6, and a conveyance speed of the sheet S is controlled so as to cancel the delay time accordingly. After the skew correction and lateral registration correction are performed in the third registration unit 100, the sheet S is sent to a secondary transfer portion. The secondary transfer portion is a nip portion formed between the secondary transfer roller 56 and the intermediate transfer belt 506.

In parallel with a conveyance operation of the sheet S to the secondary transfer portion described above, formation of the toner image is performed in the image forming unit 1B. The photosensitive drum 508 and the intermediate transfer belt 506 are rotationally driven in predetermined directions A and B. In each process unit 513, a surface of the photosensitive drum 508 is charged by the charging device. The exposure device 511 exposes the photosensitive drum 508 based on image information, and writes an electrostatic latent image on the surface of the photosensitive drum 508. The developing device 510 supplies toner serving as a developer to the photosensitive drum 508, and develops the electrostatic latent image into a single-color toner image of yellow, magenta, cyan, or black. Such a single-color toner image is primarily transferred from the photosensitive drum 508 to the intermediate transfer belt 506 by the primary transfer roller 507. At this time, the single-color toner images of the four colors are superimposed on each other on the intermediate transfer belt 506, whereby the full-color image is formed on the intermediate transfer belt 506. The residual toner remaining on the photosensitive drum 508 without being transferred to the intermediate transfer belt 506 is removed by the cleaning device 509.

The full-color toner image is conveyed to the secondary transfer portion by the rotation of the intermediate transfer belt 506. Then, in the secondary transfer portion, the toner image is transferred from the intermediate transfer belt 506 to the sheet S by voltage application to the secondary transfer roller 56.

The sheet S having passed through the secondary transfer portion is conveyed to the fixing device 58 by the pre-fixing conveyance unit 57. The fixing device 58 heats the image on the sheet S by heat generated by a heat source such as a halogen lamp and fixes the image onto the sheet S while nipping and conveying the sheet S by, for example, a roller pair. The sheet S having passed through the fixing device 58 is directly discharged toward a discharge tray 500 or guided to the reverse discharge unit 550 by the branch conveyance unit 59. The image forming apparatus 1A can discharge the sheet S to the discharge tray 500 in a state in which the sheet S is reversed by the reverse discharge unit 550 such that a side onto which the image is transferred at the secondary transfer portion faces downward.

In the case of duplex printing in which images are formed on both sides of the sheet S, the sheet S having a first side on which the image is formed is sent from the branch conveyance unit 59 to the duplex reversing unit 501 through the reverse discharge unit 550. Then, the sheet S switched back in the duplex reversing unit 501 is sent to the pre-registration conveyance unit 54 again via the duplex conveyance unit 502. Then, after the image is formed on a second side of the sheet S similarly to the first side, the sheet S is discharged to the discharge tray 500.

The sheet conveyed from the downstream deck 2A described below is conveyed to the third registration unit 100 via a merging conveyance path 110 for merging from the downstream deck 2A. An operation performed at a position downstream of the pre-registration conveyance unit 54 is the same as that in a case where the sheet S in the storage 51 is fed.

### Downstream Deck

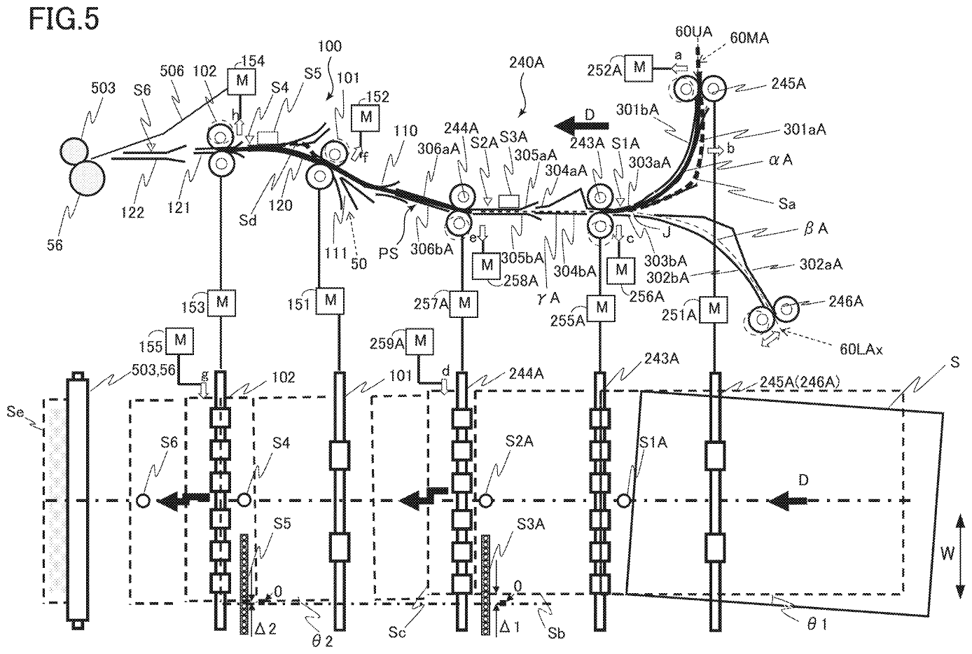

Next, the downstream deck 2A serving as the sheet feeding apparatus or the first sheet feeding apparatus according to the first embodiment will be described with reference to FIGS. 1 and 5. FIG. 5 is a schematic view illustrating configurations of a first registration unit and a second registration unit according to the first embodiment.

In the first embodiment, the downstream deck 2A feeds the sheet S toward the image forming apparatus 1A. As illustrated in FIG. 1, the downstream deck 2A according to the first embodiment includes sheet feeding units 60UA, 60MA, and 60LA serving as three-stage first feeding units arranged vertically. In addition, the downstream deck 2A includes a second registration unit 240A serving as a first correction unit that can perform the skew correction on the sheet S and can perform the lateral registration correction on the position of the sheet S in the width direction. The first correction unit is disposed on a first conveyance path γA described below. Further, the downstream deck 2A includes a relay conveyance device 400 that relays and conveys the sheet conveyed from the upstream deck 2B described in detail below.

In the description of the present embodiment, a conveyance path PS that guides the sheet from the upstream deck 2B to the image forming apparatus 1A through the relay conveyance device 400 and the second registration unit 240A of the downstream deck 2A is considered as a main conveyance path. That is, the description will be given assuming that the sheets fed from the respective sheet feeding units described below merge into the conveyance path PS. Therefore, a sheet conveyance direction D in the present specification basically refers to a direction along a direction of the conveyance path PS. A width direction W orthogonal to the sheet conveyance direction D is a front-rear direction (front-back direction) in the image forming system 1. In general, a front side in the image forming system 1 is a direction in which an operation panel (not shown) faces.

Each of the sheet feeding units 60UA, 60MA, and 60LA has the same configuration as the sheet feeding unit 50 in the main body. That is, the sheet feeding units 60UA, 60MA, and 60LA respectively include storages 61UA, 61MA, and 61LA that are so-called cassettes, and lift plates 62UA, 62MA, and 62LA that support the sheets. The sheet feeding units 60UA, 60MA, and 60LA respectively include air separation units 65UA, 65MA, and 65LA that blow air to the sheets supported by the lift plates 62UA, 62MA, and 62LA to separate the sheets. The sheet feeding units 60UA, 60MA, and 60LA respectively include air feeding units 63UA, 63MA, and 63LA that feed the sheets separated by air by air suction.

The sheets S in the storages 61UA, 61MA, and 61LA are stored in a state of being supported on the lift plates 62UA, 62MA, and 62LA, and are lifted and lowered by a lift-up device (not shown). The air separation units 65UA, 65MA, and 65LA separate several uppermost sheets S in the storages 61UA, 61MA, and 61LA by blowing high-pressure air toward upstream edges of the sheets S in the sheet conveyance direction. Then, the separated sheets S are fed one by one by the air feeding units 63UA, 63MA, and 63LA.

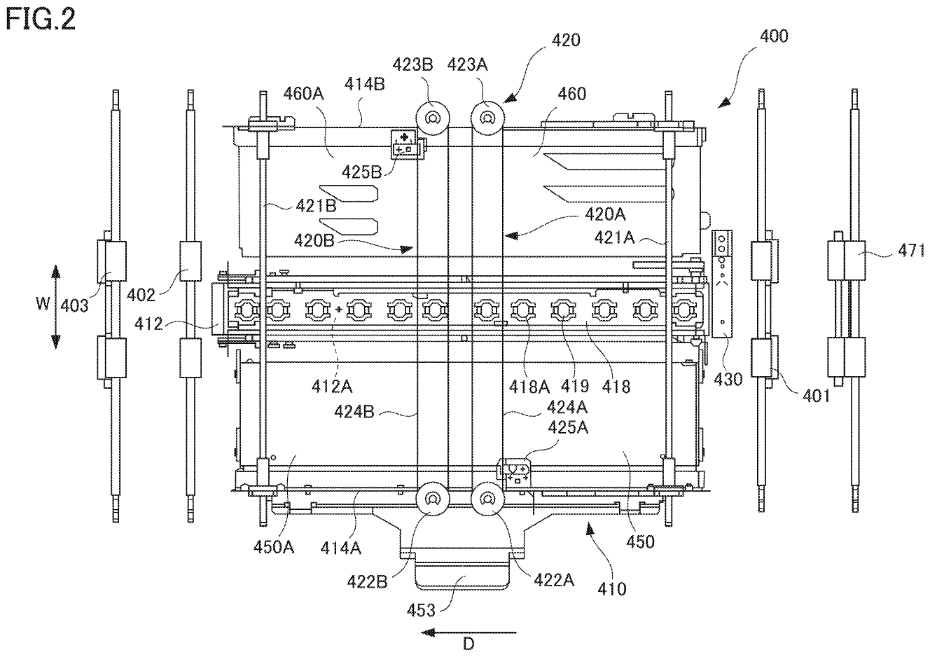

As illustrated in FIGS. 2 and 5, the sheets S fed from the upper and middle sheet feeding units 60UA and 60MA are conveyed through an upper conveyance path αA which is a sheet conveyance path. The sheet fed from the lower sheet feeding unit 60LA is conveyed through a lower conveyance path βA which is a sheet conveyance path. The upper conveyance path αA and the lower conveyance path βA merge into the conveyance path PS at a merging portion J of the second registration unit 240A, and communicate with a horizontal path γA which is a part of the conveyance path PS. The horizontal path γA is a first conveyance path through which the sheet fed from the first feeding unit is conveyed toward the image forming apparatus 1A. The horizontal path γA extends in a substantially horizontal direction and communicates with the merging conveyance path 110 of the image forming apparatus 1A. Therefore, the sheet S fed from each of the sheet feeding units 60UA, 60MA, and 60LA is conveyed to the image forming apparatus 1A via the second registration unit 240A. The downstream deck 2A includes the first conveyance path γA and a third conveyance path (a receiving conveyance path 470 and a conveyance path 215 described below) connected to the first conveyance path γA.

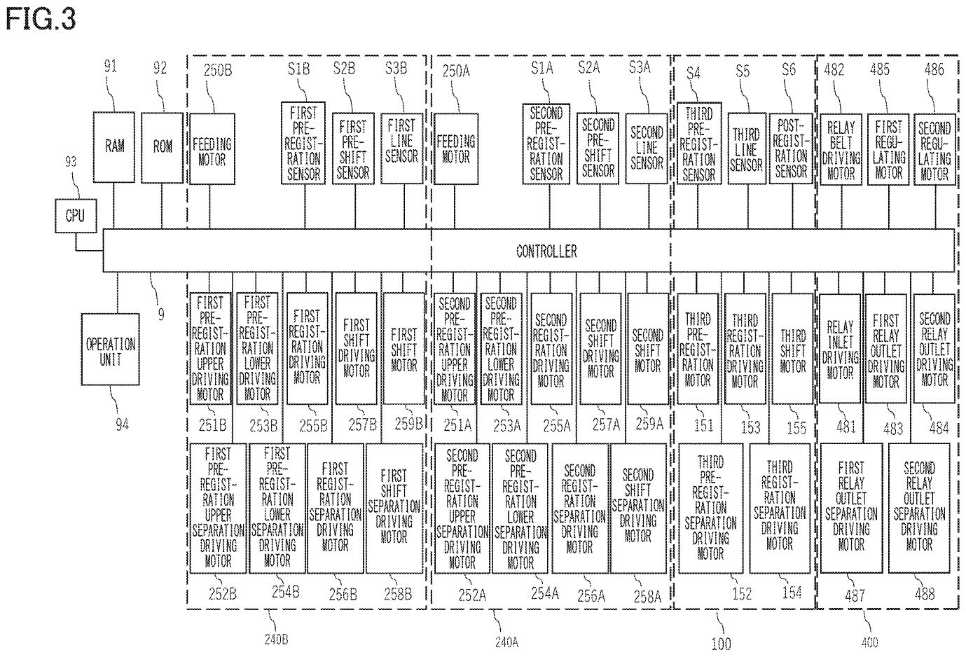

Similarly to the sheet feeding unit 50 of the image forming apparatus 1A, in the image forming operation, the sheet S is fed from any one of the sheet feeding units 60UA, 60MA, and 60LA according to the operation timing of the image forming unit 1B. A controller 9 (see FIG. 3) serving as a control unit of the image forming apparatus 1A temporarily stops a second shift roller pair 244A based on detection of the leading edge of the sheet by a second pre-shift sensor S2A to cause the sheet S to abut against a nip portion of the stopped second shift roller pair 244A and buckle. Thereafter, the second shift roller pair 244A is driven according to the operation timing of the image forming unit 1B based on a timing when the leading edge of the sheet is detected by the second pre-shift sensor S2A, and the conveyance of the sheet S is resumed. As a result, it is possible to feed the sheet S to the image forming apparatus 1A while correcting skew of the sheet S and correcting variations in conveyance timing in the downstream deck 2A.

The skew correction at the second shift roller pair 244A and adjustment of the operation timing of the image forming unit 1B can be performed using a second registration roller pair 243A. In the downstream deck 2A in the present embodiment, for example, in a case where the sheet S is a sheet such as thick paper or plain paper, which has higher stiffness than thin paper, the skew correction is performed at the second registration roller pair 243A. When the sheet S is a sheet having low stiffness such as thin paper, the skew correction is performed at the second shift roller pair 244A. As a result, for example, it is possible to prevent the sheet from slipping through the second shift roller pair 244A due to a large thrust force generated by buckling of the sheet in a case where the skew correction is performed on a sheet having high stiffness, such as thick paper, by the second shift roller pair 244A. In contrast, for example, it is possible to prevent occurrence of a skew correction failure due to an insufficient thrust force generated by buckling and the leading edge of the sheet not following the second registration roller pair 243A in a case where the skew correction is performed on a sheet having low stiffness, such as thin paper, at the second registration roller pair 243A.

### Configurations of Second Registration Unit and Third Registration Unit

Next, configurations of the second registration unit 240A of the downstream deck 2A and the third registration unit 100 of the image forming apparatus 1A according to the first embodiment will be described in detail with reference to FIG. 5.

### Configuration of Second Registration Unit

As illustrated in FIG. 5, the second registration unit 240A includes the second registration roller pair 243A serving as a second conveyance roller pair, a second upper conveyance roller pair 245A, a second lower conveyance roller pair 246A, and the second shift roller pair 244A serving as a first conveyance roller pair.

The second registration roller pair 243A and the second shift roller pair 244A are disposed on the horizontal path γA which is a part of the conveyance path PS. The second shift roller pair 244A is positioned downstream of the second registration roller pair 243A in the sheet conveyance direction D on the horizontal path γA.

The second upper conveyance roller pair 245A is disposed on the upper conveyance path αA and is positioned upstream of the second registration roller pair 243A in the sheet conveyance direction D on the upper conveyance path αA. The second lower conveyance roller pair 246A is disposed on the lower conveyance path βA and is positioned upstream of the second registration roller pair 243A in the sheet conveyance direction D on the lower conveyance path βA.

The second upper conveyance roller pair 245A includes a driving roller that is rotationally driven by a driving force of a second pre-registration upper driving motor 251A (M in the figure represents a motor), and a driven roller that forms a nip portion together with the driving roller and rotates following the driving roller. In addition, the second upper conveyance roller pair 245A is configured such that the driving roller and the driven roller can abut against and be separated from each other (to open and close the nip portion) by a driving force of a second pre-registration upper separation driving motor 252A.

Similarly, the second lower conveyance roller pair 246A includes a driving roller that is rotationally driven by a driving force of a second pre-registration lower driving motor 253A (see FIG. 3), and a driven roller that forms a nip portion together with the driving roller and rotates following the driving roller. In addition, the second lower conveyance roller pair 246A is configured such that the driving roller and the driven roller can abut against and be separated from each other (to open and close the nip portion) by a driving force of a second pre-registration lower separation driving motor 254A (see FIG. 3).

Similarly, the second registration roller pair 243A includes a driving roller that is rotationally driven by a driving force of a second registration driving motor 255A, and a driven roller that forms a nip portion together with the driving roller and rotates following the driving roller. The second registration roller pair 243A is configured such that the driving roller and the driven roller can abut against and be separated from each other (to open and close the nip portion) by a driving force of a second registration separation driving motor 256A.

Similarly, the second shift roller pair 244A includes a driving roller that is rotationally driven by a driving force of a second shift driving motor 257A, and a driven roller that forms a nip portion together with the driving roller and rotates following the driving roller. In addition, the second shift roller pair 244A is configured such that the driving roller and the driven roller can abut against and be separated from each other (to open and close the nip portion) by a driving force of a second shift separation driving motor 258A.

Therefore, in the present embodiment, the rotational driving of each of the roller pairs (243A, 244A, 245A, and 246A) can be independently controlled. Further, each of the roller pairs (243A, 244A, 245A, and 246A) is configured such that the driving roller and the driven roller can be independently controlled to abut against or be separated from each other (to open and close the nip portion).

Further, the second shift roller pair 244A is configured to be shiftable in a sheet width direction by a driving force of a second shift motor 259A. The sheet width direction is a direction parallel to a rotation axis of the second shift roller pair 244A. The second shift motor 259A functions as a first movement driving unit for the lateral registration correction in which the second shift roller pair 244A is moved in the sheet width direction based on the detection result of the second line sensor S3A to correct a positional deviation in the width direction.

Between the second upper conveyance roller pair 245A and the second registration roller pair 243A, the upper conveyance path αA serving as a first curved conveyance path is formed by an upper guide 301bA and a lower guide 301aA serving as first curved guide portions. The upper conveyance path αA is curved when viewed from the width direction W such that the lower guide 301aA is positioned on an outer side of the curve and the upper guide 301bA is positioned on an inner side of the curve between the second upper conveyance roller pair 245A and the second registration roller pair 243A. The lower guide 301aA is a swingable guide pressed by a spring (not shown). When the sheet S forms a loop, the lower guide 301aA pivots so as to be curved outward and forms a space that allows the loop formed when the sheet S abuts against the nip portion of the second registration roller pair 243A. As a result, for example, in a thick paper mode in which the type of the sheet to be fed is thick paper, the skew correction can be performed in a state in which the sheet S is greatly curved along the curved upper conveyance path αA. As a result, a possibility of a skew correction failure due to the leading edge slipping through the second registration roller pair 243A or slippage of the second upper conveyance roller pair 245A is more reliably reduced.

Between the second lower conveyance roller pair 246A and the second registration roller pair 243A, the lower conveyance path βA serving as the first curved conveyance path is formed by an upper guide 302aA and a lower guide 302bA serving as the first curved guide portions. The lower conveyance path βA is curved such that the lower guide 302bA is positioned on an inner side of the curve and the upper guide 302aA is positioned on an outer side of the curve between the second lower conveyance roller pair 246A and the second registration roller pair 243A. A distance between the lower guide 302bA and the upper guide 302aA is larger at an intermediate portion between the second lower conveyance roller pair 246A and the second registration roller pair 243A than in the vicinity of the second lower conveyance roller pair 246A and the vicinity of the second registration roller pair 243A. Therefore, a space that allows buckling of (the loop formed by) the sheet S toward the outer side of the curve of the lower conveyance path βA is formed at the intermediate portion between the second lower conveyance roller pair 246A and the second registration roller pair 243A. As a result, similarly, for example, in the thick paper mode, the skew correction can be performed in a state in which the sheet S is greatly curved along the curved lower conveyance path βA. As a result, a possibility of a skew correction failure due to the leading edge slipping through the second registration roller pair 243A or slippage of the second lower conveyance roller pair 246A is more reliably reduced.

The upper conveyance path αA and the lower conveyance path βA merge into the conveyance path PS at the merging portion J in the vicinity of an upstream side of the second registration roller pair 243A. A conveyance path positioned downstream of the merging portion J of the upper conveyance path αA and the lower conveyance path βA is formed by an upper guide 303aA and a lower guide 303bA.

The horizontal path γA is formed between the second registration roller pair 243A and the second shift roller pair 244A by an upper guide 304aA and a lower guide 304bA. In the horizontal path γA, a part of the upper guide 304aA is recessed upward. In other words, the upper guide 304aA has a recess in which a part of the upper guide 304aA in the sheet conveyance direction D is recessed so as to be positioned away (retract) from the lower guide 304bA. As a result, a space that allows upward buckling of (the loop formed by) the sheet S is formed between the second registration roller pair 243A and the second shift roller pair 244A. That is, for example, in a thin paper mode in which the type of the sheet to be fed is thin paper, the space for receiving the loop of the sheet S is provided at an upper portion of the horizontal path γA. Since the thin paper (in particular, ultra-thin paper) has low stiffness, if the space for receiving the loop is provided at a lower portion of the horizontal path γA, the sheet S buckles toward the space before the loop is formed, which may cause a skew correction failure. With the configuration of the present embodiment, such inconvenience can be avoided.

The second registration unit 240A includes a second pre-registration sensor S1A, the second pre-shift sensor S2A, and the second line sensor S3A serving as a first widthwise position detection unit that detects the side edge of the sheet from an image. The second pre-registration sensor S1A is disposed in the vicinity of the upstream side of the second registration roller pair 243A. The second pre-shift sensor S2A is disposed in the vicinity of an upstream side of the second shift roller pair 244A. The second line sensor S3A is disposed such that a sheet detection position serving as a first detection position is positioned in the vicinity of the upstream side of the second shift roller pair 244A.

The second pre-registration sensor S1A and the second pre-shift sensor S2A are used to acquire passage timings of the leading edge and a trailing edge of the sheet S in order to control a sheet conveyance operation. The second pre-registration sensor S1A is used, for example, for conveyance control including control of a buckling amount (loop amount) when the skew correction is performed by causing the leading edge of the sheet S to abut against the nip portion of the second registration roller pair 243A. The second pre-shift sensor S2A is used, for example, for conveyance control including control of a buckling amount (loop amount) when the skew correction is performed by causing the leading edge of the sheet S to abut against the nip portion of the second shift roller pair 244A.

The second line sensor S3A is, for example, a CIS (Contact Image Sensor) type line sensor including light receiving elements arranged in the sheet width direction. In the present embodiment, the lateral registration correction is performed by shifting the second shift roller pair 244A in the sheet width direction in a state in which the second shift roller pair 244A nips the sheet S based on the detection result of the second line sensor S3A. When the lateral registration correction is performed using the second shift motor 259A, the sheet is nipped by pressure contact between the driving roller and the driven roller driven by the second shift separation driving motor 258A and is moved in the width direction. After performing the lateral registration correction, the second shift motor 259A returns a position of the second shift roller pair 244A in the sheet width direction to an initial position. At this time, the second shift separation driving motor 258A separates the driving roller and the driven roller to release the sheet.

As described above, the sheet S subjected to the lateral registration correction is conveyed to a discharge path formed by an upper guide 306aA and a lower guide 306bA. Then, the sheet S is delivered to the merging conveyance path 110 of the image forming apparatus 1A.

### Configuration of Third Registration Unit

Next, the third registration unit 100 serving as the third correction unit of the image forming apparatus 1A will be described. The third pre-registration roller pair 101 is disposed downstream of the merging conveyance path 110 connected to the downstream deck 2A and the conveyance path 111 connected to the sheet feeding unit 50 in the sheet conveyance direction D. The third registration roller pair 102 is disposed downstream of the third pre-registration roller pair 101 in the sheet conveyance direction D.

The third pre-registration roller pair 101 includes a driving roller that is rotationally driven by a driving force of a third pre-registration motor 151, and a driven roller that forms a nip portion together with the driving roller and rotates following the driving roller. The third pre-registration roller pair 101 is configured such that the driving roller and the driven roller can abut against and be separated from each other (to open and close the nip portion) by receiving a driving force of a third pre-registration separation driving motor 152 via a transmission gear (not shown).

The third registration roller pair 102 includes a driving roller that is rotationally driven by a driving force of a third registration driving motor 153, and a driven roller that forms a nip portion together with the driving roller and rotates following the driving roller. The third registration roller pair 102 is configured such that the driving roller and the driven roller can abut against and be separated from each other (to open and close the nip portion) by receiving a driving force of a third registration separation driving motor 154 via a transmission gear (not shown).

Further, the third registration roller pair 102 is configured to be shiftable in the sheet width direction by a driving force of a third shift motor 155. The sheet width direction is a direction parallel to a rotation axis of the third registration roller pair 102. The third shift motor 155 functions as a movement driving unit for lateral registration correction in which the third registration roller pair 102 is moved in the sheet width direction based on a detection result of the third line sensor S5 to correct a positional deviation in the width direction.

Between the third pre-registration roller pair 101 and the third registration roller pair 102, a curved guide 120 for guiding the conveyed sheet and a guide for introducing the leading edge of the sheet to the nip portion are disposed. A gap in the curved guide 120 in a thickness direction of the sheet has a size partially increasing toward an outer side of the curve. As a result, a loop formed by the sheet S conveyed from the third pre-registration roller pair 101 and abutting against the nip portion of the third registration roller pair 102 is allowed. The third pre-registration sensor S4 that detects the sheet S and the third line sensor S5 that detects the side edge of the sheet from an image are disposed on the curved guide 120. The third line sensor S5 is, for example, a CIS (Contact Image Sensor) type line sensor including light receiving elements arranged in the sheet width direction. The third line sensor S5 can acquire information regarding a position of the side edge of the sheet S in the sheet width direction. The third line sensor S5 is used for alignment (lateral registration correction) of the image formed by the image forming unit 1B with respect to the sheet S in the sheet width direction (main scanning direction).

Further, a guide 122 that delivers the sheet to the secondary transfer portion (between the secondary transfer roller 56 and the intermediate transfer belt 506) is disposed downstream of the third registration roller pair 102 in the sheet conveyance direction D. The post-registration sensor S6 that detects the sheet S is disposed on the guide 122.

### Configuration of Relay Conveyance Device

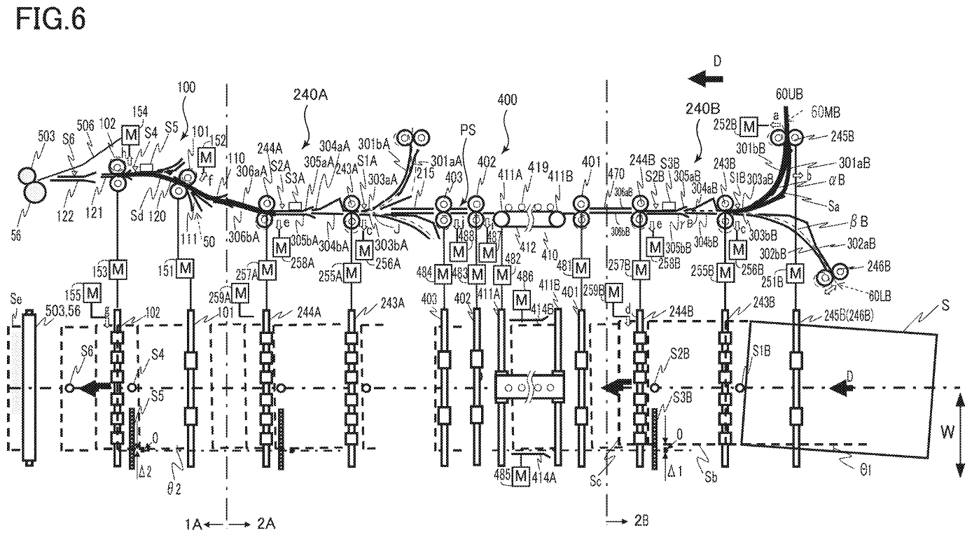

Next, a configuration of the relay conveyance device 400 provided in the downstream deck 2A will be described with reference to FIGS. 2 and 6. FIG. 2 is a top view illustrating the relay conveyance device according to the first embodiment. FIG. 6 is a schematic view illustrating configurations of the first registration unit, the first sheet feeding apparatus, and the second sheet feeding apparatus according to the first embodiment.

As illustrated in FIG. 1, the sheet fed from the upstream deck 2B to the downstream deck 2A is delivered to an inlet roller pair 401 through the receiving conveyance path 470 which is a part of the conveyance path PS, and is conveyed to the relay conveyance device 400 by the inlet roller pair 401. As illustrated in FIGS. 2 and 6, the relay conveyance device 400 includes a positional deviation correction unit 410 serving as a second correction unit. The second correction unit is disposed upstream of the first conveyance path and downstream of a second feeding unit. The relay conveyance device 400 can perform lateral registration correction and skew correction in the positional deviation correction unit 410, and conveys the sheet to the second registration unit 240A by a pre-outlet roller pair 402 and an outlet roller pair 403. That is, the relay conveyance device 400 can correct a positional deviation of the sheet conveyed from the upstream deck 2B positioned upstream of the relay conveyance device 400 in the sheet conveyance direction D (alternatively, an apparatus positioned upstream of the relay conveyance device 400 in a case where another apparatus is connected), and delivers the sheet to a downstream side. Hereinafter, a schematic configuration of the relay conveyance device 400 will be described in detail.

As illustrated in FIGS. 2 and 6, the relay conveyance device 400 conveys the sheet in the conveyance path PS. The relay conveyance device 400 includes the positional deviation correction unit 410, the inlet roller pair 401 disposed upstream of the positional deviation correction unit 410 in the sheet conveyance direction D, and the pre-outlet roller pair 402 and the outlet roller pair 403 disposed downstream of the positional deviation correction unit 410 in the sheet conveyance direction D on the conveyance path PS.

The inlet roller pair 401 includes a driving roller that is rotationally driven by a driving force of a relay inlet driving motor 481, and a driven roller that forms a nip portion together with the driving roller and rotates following the driving roller. Similarly, the pre-outlet roller pair 402 includes a driving roller that is rotationally driven by a driving force of a first relay outlet driving motor 483, and a driven roller that forms a nip portion together with the driving roller and rotates following the driving roller. In addition, the pre-outlet roller pair 402 is configured such that the driving roller and the driven roller can abut against and be separated from each other (to open and close the nip portion) by a driving force of a first relay outlet separation driving motor 487. Similarly, the outlet roller pair 403 includes a driving roller that is rotationally driven by a driving force of a second relay outlet driving motor 484, and a driven roller that forms a nip portion together with the driving roller and rotates following the driving roller. In addition, the outlet roller pair 403 is configured such that the driving roller and the driven roller can abut against and be separated from each other (to open and close the nip portion) by a driving force of a second relay outlet separation driving motor 488.

Next, a configuration of the positional deviation correction unit 410 will be described in detail. The positional deviation correction unit 410 includes a conveyor belt 412 serving as a belt, a plurality of spheres 419, opposing members 450 and 460, a pair of first regulating guide 414A and second regulating guide 414B, a guide movement unit 420, and the like.

The conveyor belt 412 is disposed downstream of the inlet roller pair 401 in the sheet conveyance direction D, the inlet roller pair 401 serving as a conveyance member that conveys the sheet. The conveyor belt 412 is an endless belt stretched around two pulleys (not shown), and has a conveyance surface 412A extending in the sheet conveyance direction D. A relay belt driving motor 482 (see FIGS. 3 and 6) is connected to one of the pulleys, and the conveyor belt 412 rotates by driving of the relay belt driving motor 482. Such a conveyor belt 412 conveys, in the sheet conveyance direction D, the sheet delivered from the inlet roller pair 401 on the upstream side in the sheet conveyance direction D to the conveyance surface 412A.

The plurality of spheres 419 are arranged in the sheet conveyance direction D at positions facing the conveyance surface 412A of the conveyor belt 412 from above. The plurality of spheres 419 can rotate in an arbitrary direction while nipping the sheet with the conveyance surface 412A. Therefore, each of the plurality of spheres 419 is rotatably held in an arbitrary direction by a holding plate 418 provided above the conveyor belt 412. That is, as illustrated in FIG. 2, the holding plate 418 is a long plate disposed in the sheet conveyance direction D at a position separated from the conveyance surface 412A by a predetermined distance above the conveyor belt 412, and has a plurality of holding holes 418A spaced apart from each other in the sheet conveyance direction D. The spheres 419 are rotatably held in the holding holes 418A, respectively. The sphere 419 is exposed from the holding hole 418A, is disposed to face the conveyance surface 412A of the conveyor belt 412 from above, and is rotatable in an arbitrary direction. Each sphere 419 abuts against the conveyance surface 412A by its own weight. It is sufficient if the number of spheres 419 is set according to a pressing force required for the sheet conveyed on the conveyor belt 412. Further, since the sheet is conveyed while slipping on the conveyor belt 412 as described below, the sphere 419 is preferably made of a material such as glass or plastic having a relatively low frictional coefficient. In the present embodiment, a configuration in which the plurality of spheres 419 are arranged in one row in the sheet conveyance direction D has been described, but the plurality of spheres 419 may be arranged in a plurality of rows such as two rows in the sheet conveyance direction D.

The opposing members 450 and 460 are disposed on both sides of the conveyor belt 412 in the width direction W, and upper surfaces 450A and 460A thereof form guide surfaces below the conveyance path PS.

The pair of first regulating guide 414A and second regulating guide 414B is disposed on both sides of the conveyor belt 412 in the width direction W orthogonal to the sheet conveyance direction D. The first regulating guide 414A and the second regulating guide 414B are configured to be capable of guiding while regulating positions of both edges of the sheet in the width direction W, the sheet being conveyed while being nipped between the conveyor belt 412 and the sphere 419. The second regulating guide 414B disposed on one side of the conveyor belt 412 in the width direction W can guide one side edge of the sheet in the width direction W, the sheet being conveyed while being nipped between the conveyor belt 412 and the sphere 419. The first regulating guide 414A disposed on the other side of the conveyor belt 412 in the width direction W can guide the other side edge of the sheet in the width direction W, the sheet being conveyed while being nipped between the conveyor belt 412 and the sphere 419.

The pair of first regulating guide 414A and second regulating guide 414B is supported by support shafts 421A and 421B so as to be movable to a guiding position and a retracted position by the guide movement unit 420. The support shafts 421A and 421B are disposed substantially parallel to the width direction W, and support both end portions of the pair of first regulating guide 414A and second regulating guide 414B in the sheet conveyance direction D. That is, the pair of first regulating guide 414A and second regulating guide 414B is movable in the width direction W along the support shafts 421A and 421B.

The guide movement unit 420 serving as a third movement driving unit includes a first movement unit 420A that moves the first regulating guide 414A and a second movement unit 420B that moves the second regulating guide 414B. The guide movement unit 420 includes a first regulating motor 485 that generates a driving force for moving the first regulating guide 414A and a second regulating motor 486 that generates a driving force for moving the second regulating guide 414B. In the present embodiment, the pair of first regulating guide 414A and second regulating guide 414B are independently movable.

Specifically, the first movement unit 420A includes a pair of pulleys 422A and 423A, an endless belt 424A stretched around both pulleys 422A and 423A, and a connection unit 425A that connects the belt 424A and the first regulating guide 414A. Similarly, the second movement unit 420B includes a pair of pulleys 422B and 423B, an endless belt 424B stretched around both pulleys 422B and 423B, and a connection unit 425B that connects the belt 424B and the second regulating guide 414B.

As illustrated in FIG. 2, the first movement unit 420A is driven by the first regulating motor 485, and the second movement unit 420B is driven by the second regulating motor 486. That is, the pulley 422A of the first movement unit 420A is coupled to a pulley via a coupling shaft, and a belt is stretched between the pulley and a pulley rotationally driven by the first regulating motor 485. The rotational driving of the first regulating motor 485 is transmitted to the belt 424A via the belt, the pulley, the coupling shaft, and the pulley 422A. Since the first regulating guide 414A is connected to the belt 424A via the connection unit 425A, the first regulating guide 414A moves in the width direction W along the support shafts 421A and 421B by driving of the first regulating motor 485.

Similarly, the pulley 422B of the second movement unit 420B is coupled to a pulley via a coupling shaft, and a belt is stretched between the pulley and a pulley rotationally driven by the second regulating motor 486. The rotational driving of the second regulating motor 486 is transmitted to the belt 424B via the belt, the pulley, the coupling shaft, and the pulley 422B. Since the second regulating guide 414B is connected to the belt 424B via the connection unit 425B, the second regulating guide 414B moves in the width direction W along the support shafts 421A and 421B by driving of the second regulating motor 486.

### Upstream Deck

Next, the upstream deck 2B serving as the second sheet conveyance apparatus according to the first embodiment will be described with reference to FIGS. 1 and 6. The upstream deck 2B according to the first embodiment has a configuration substantially similar to that of the downstream deck 2A described above, and specifically, has a configuration similar to that in which the relay conveyance device 400 is eliminated from the downstream deck 2A.

That is, as illustrated in FIG. 1, the upstream deck 2B feeds the sheet S toward the downstream deck 2A. The upstream deck 2B includes sheet feeding units 60UB, 60MB, and 60LB serving as three-stage second feeding units arranged vertically. The upstream deck 2B includes a first registration unit 240B that can perform skew correction on the sheet S and can perform lateral registration correction on a position of the sheet S in the width direction.

The sheet feeding units 60UB, 60MB, and 60LB respectively include storages 61UB, 61MB, and 61LB that are so-called cassettes, and lift plates 62UB, 62MB, and 62LB that support the sheets. The sheet feeding units 60UB, 60MB, and 60LB respectively include air separation units 65UB, 65MB, and 65LB that blow air to the sheets supported by the lift plates 62UB, 62MB, and 62LB to separate the sheets. The sheet feeding units 60UB, 60MB, and 60LB respectively include air feeding units 63UB, 63MB, and 63LB that feed the sheets separated by air by air suction. Since operations of the sheet feeding units 60UB, 60MB, and 60LB are similar to those of the sheet feeding units 60UA, 60MA, and 60LA described above, the description thereof will be omitted.

### Configuration of First Registration Unit

As illustrated in FIG. 6, the first registration unit 240B serving as the second correction unit includes a first registration roller pair 243B serving as a fourth conveyance roller pair and a first shift roller pair 244B serving as a third conveyance roller pair. The first registration unit 240B includes a first upper conveyance roller pair 245B and a first lower conveyance roller pair 246B. The first registration unit 240B is disposed upstream of the first conveyance path and downstream of the second feeding unit, and more specifically, is disposed on a second conveyance path described below.

The first registration roller pair 243B and the first shift roller pair 244B are disposed on a horizontal path γB. The horizontal path γB is a second conveyance path through which the sheet fed from the second feeding unit is conveyed toward the third conveyance path (the receiving conveyance path 470 and the conveyance path 215 described below). The first shift roller pair 244B is positioned downstream of the first registration roller pair 243B in the sheet conveyance direction D on the horizontal path γB.

The first upper conveyance roller pair 245B is disposed on an upper conveyance path αB and is positioned upstream of the first registration roller pair 243B in the sheet conveyance direction D on the upper conveyance path αB. The first lower conveyance roller pair 246B is disposed on a lower conveyance path βB and is positioned upstream of the first registration roller pair 243B in the sheet conveyance direction D on the lower conveyance path βB.

The first upper conveyance roller pair 245B includes a driving roller that is rotationally driven by a driving force of a first pre-registration upper driving motor 251B, and a driven roller that forms a nip portion together with the driving roller and rotates following the driving roller. In addition, the first upper conveyance roller pair 245B is configured such that the driving roller and the driven roller can abut against and be separated from each other (to open and close the nip portion) by a driving force of a first pre-registration upper separation driving motor 252B.

Similarly, the first lower conveyance roller pair 246B includes a driving roller that is rotationally driven by a driving force of a first pre-registration lower driving motor 253B (see FIG. 3), and a driven roller that forms a nip portion together with the driving roller and rotates following the driving roller. In addition, the first lower conveyance roller pair 246B is configured such that the driving roller and the driven roller can abut against and be separated from each other (to open and close the nip portion) by a driving force of a first pre-registration lower separation driving motor 254B (see FIG. 3).

Similarly, the first registration roller pair 243B includes a driving roller that is rotationally driven by a driving force of a first registration driving motor 255B, and a driven roller that forms a nip portion together with the driving roller and rotates following the driving roller. The first registration roller pair 243B is configured such that the driving roller and the driven roller can abut against and be separated from each other (to open and close the nip portion) by a driving force of a first registration separation driving motor 256B.

Similarly, the first shift roller pair 244B includes a driving roller that is rotationally driven by a driving force of a first shift driving motor 257B, and a driven roller that forms a nip portion together with the driving roller and rotates following the driving roller. In addition, the first shift roller pair 244B is configured such that the driving roller and the driven roller can abut against and be separated from each other (to open and close the nip portion) by a driving force of a first shift separation driving motor 258B.

Therefore, in the present embodiment, the rotational driving of each of the roller pairs (243B, 244B, 245B, and 246B) can be independently controlled. Further, each of the roller pairs (243B, 244B, 245B, and 246B) is configured such that the driving roller and the driven roller can be independently controlled to abut against or be separated from each other (to open and close the nip portion).

Further, the first shift roller pair 244B is configured to be shiftable in a sheet width direction by a driving force of a first shift motor 259B. The sheet width direction is a direction parallel to a rotation axis of the first shift roller pair 244B. The first shift motor 259B functions as a second movement driving unit for the lateral registration correction in which the first shift roller pair 244B is moved in the sheet width direction based on the detection result of a first line sensor S3B to correct a positional deviation in the width direction.

Between the first upper conveyance roller pair 245B and the first registration roller pair 243B, the upper conveyance path αB serving as a second curved conveyance path is formed by an upper guide 301bB and a lower guide 301aB serving as second curved guide portions. The upper conveyance path αB is curved when viewed from the width direction W such that the lower guide 301aB is positioned on an outer side of the curve and the upper guide 301bB is positioned on an inner side of the curve between the first upper conveyance roller pair 245B and the first registration roller pair 243B. The lower guide 301aB is a swingable guide pressed by a spring (not shown). When the sheet S forms a loop, the lower guide 301aB pivots so as to be curved outward and forms a space that allows the loop formed when the sheet S abuts against the nip portion of the first registration roller pair 243B. As a result, for example, in a thick paper mode in which the type of the sheet to be fed is thick paper, the skew correction can be performed in a state in which the sheet S is greatly curved along the curved upper conveyance path αB. As a result, a possibility of a skew correction failure due to the leading edge slipping through the first registration roller pair 243B or slippage of the first upper conveyance roller pair 245B is more reliably reduced.

Between the first lower conveyance roller pair 246B and the first registration roller pair 243B, the lower conveyance path βB serving as a second curved conveyance path is formed by an upper guide 302aB and a lower guide 302bB serving as second curved guide portions. The lower conveyance path βB is curved such that the lower guide 302bB is positioned on an inner side of the curve and the upper guide 302aB is positioned on an outer side of the curve between the first lower conveyance roller pair 246B and the first registration roller pair 243B. A distance between the lower guide 302bB and the upper guide 302aB is larger at an intermediate portion between the first lower conveyance roller pair 246B and the first registration roller pair 243B than in the vicinity of the first lower conveyance roller pair 246B and in the vicinity of the first registration roller pair 243B. Therefore, a space that allows buckling of (the loop formed by) the sheet S toward the outer side of the curve of the lower conveyance path βB is formed at the intermediate portion between the first lower conveyance roller pair 246B and the first registration roller pair 243B. As a result, similarly, for example, in the thick paper mode, the skew correction can be performed in a state in which the sheet S is greatly curved along the curved lower conveyance path βB. As a result, a possibility of a skew correction failure due to the leading edge slipping through the first registration roller pair 243B or slippage of the first lower conveyance roller pair 246B is more reliably reduced.

The upper conveyance path αB and the lower conveyance path βB merge into the conveyance path PS in the vicinity of an upstream side of the first registration roller pair 243B. A conveyance path positioned downstream of a merging portion of the upper conveyance path αB and the lower conveyance path βB is formed by an upper guide 303aB and a lower guide 303bB.

The horizontal path γB is formed between the first registration roller pair 243B and the first shift roller pair 244B by an upper guide 304aB and a lower guide 304bB. In the horizontal path γB, a part of the upper guide 304aB is recessed upward. In other words, the upper guide 304aB has a recess in which a part of the upper guide 304aB in the sheet conveyance direction D is recessed so as to be positioned away (retract) from the lower guide 304bB. As a result, a space that allows upward buckling of (the loop formed by) the sheet S is formed between the first registration roller pair 243B and the first shift roller pair 244B. That is, for example, in a thin paper mode in which the type of the sheet to be fed is thin paper, the space for receiving the loop of the sheet S is provided at an upper portion of the horizontal path γB. Since the thin paper (in particular, ultra-thin paper) has low stiffness, if the space for receiving the loop is provided at a lower portion of the horizontal path γB, the sheet S buckles toward the space before the loop is formed, which may cause a skew correction failure. With the configuration of the present embodiment, such inconvenience can be avoided.

The first registration unit 240B includes a first pre-registration sensor S1B, a first pre-shift sensor S2B, and the first line sensor S3B serving as a second widthwise position detection unit that detects the side edge of the sheet from an image. The first pre-registration sensor S1B is disposed in the vicinity of the upstream side of the first registration roller pair 243B. The first pre-shift sensor S2B and the first line sensor S3B are disposed in the vicinity of an upstream side of the first shift roller pair 244B. The first line sensor S3B is disposed such that a sheet detection position serving as a second detection position is positioned in the vicinity of the upstream side of the first shift roller pair 244B.

The first pre-registration sensor S1B and the first pre-shift sensor S2B are used to acquire passage timings of the leading edge and the trailing edge of the sheet S in order to control the sheet conveyance operation. The first pre-registration sensor S1B is used, for example, for conveyance control including control of a buckling amount (loop amount) when the skew correction is performed by causing the leading edge of the sheet S to abut against the nip portion of the first registration roller pair 243B. The first pre-shift sensor S2B is used, for example, for conveyance control including control of a buckling amount (loop amount) when the skew correction is performed by causing the leading edge of the sheet S to abut against the nip portion of the first shift roller pair 244B.

The first line sensor S3B is, for example, a CIS (Contact Image Sensor) type line sensor including light receiving elements arranged in the sheet width direction. In the present embodiment, the lateral registration correction is performed by shifting the first shift roller pair 244B in the sheet width direction in a state in which the first shift roller pair 244B nips the sheet S based on the detection result of the first line sensor S3B. When the lateral registration correction is performed using the first shift motor 259B, the sheet is nipped by pressure contact between the driving roller and the driven roller driven by the first shift separation driving motor 258B and is moved in the width direction. After performing the lateral registration correction, the first shift motor 259B returns a position of the first shift roller pair 244B in the sheet width direction to an initial position. At this time, the first shift separation driving motor 258B separates the driving roller and the driven roller to release the sheet.

As described above, the sheet S subjected to the lateral registration correction is conveyed to a discharge path formed by an upper guide 306aB and a lower guide 306bB. Then, the sheet S is delivered to the receiving conveyance path 470 of the downstream deck 2A.

### Configuration of Control System of Image Forming System

Next, a control system of the image forming system according to the first embodiment will be described with reference to FIG. 3. FIG. 3 is a block diagram illustrating the control system of the image forming system according to the first embodiment.

As illustrated in FIG. 3, the controller 9 serving as the control unit includes a central processing unit (CPU) 93, a random access memory (RAM) 91, and a read only memory (ROM) 92, and is connected to an operation unit 94 and to an external computer via an interface (not shown). The CPU 93 of the controller 9 reads and executes a control program stored in the ROM 92 according to a command signal based on an operation input of the external computer or the operation unit 94, and performs various controls while using the RAM 91 as a work memory.

Further, the controller 9 is connected to each motor and each sensor of the first registration unit 240B of the upstream deck 2B, the second registration unit 240A of the downstream deck 2A, the third registration unit 100 of the image forming apparatus 1A, and the relay conveyance device 400 described above. The operations thereof will be described in detail in the following description of sheet conveyance control in the image forming system.

### Sheet Conveyance Control

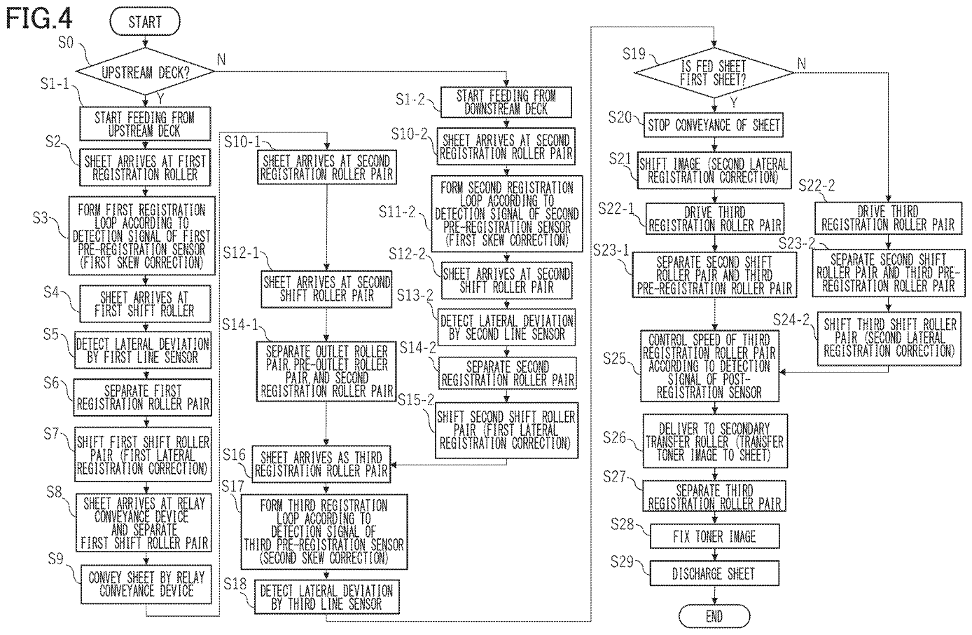

Next, the sheet conveyance control in the image forming system 1 will be described with reference to FIGS. 4, 5, and 6. FIG. 4 is a flowchart illustrating the sheet conveyance control in the image forming system according to the first embodiment.

Sheet Feeding from Downstream Deck

First, a case where the sheet is fed from the downstream deck 2A to the image forming unit 1B of the image forming apparatus 1A will be described with reference to FIGS. 4 and 5.

For example, when the controller 9 receives a print job (print start command) by an operation input of the operation unit 94 from a user or by a command from the external computer connected via a network, the controller 9 starts the sheet conveyance control illustrated in FIG. 4. The print job received by the controller 9 includes information designated by the user, such as the number of prints, and a size and a type (thick paper, plain paper, thin paper, coated paper, or the like) of the sheet S to be printed.

When the sheet conveyance control (that is, print processing) is started, first, the controller 9 determines the sheet S of the size and the type designated in the print job. Then, a sheet feeding unit that stores a sheet matching the determined size and type of the sheet is selected from among the respective sheet feeding units of the image forming system 1. Here, it is assumed that the selected sheet feeding unit is one of the sheet feeding units 60UA, 60MA, and 60LA of the downstream deck 2A (N in S0), and any one of the sheet feeding units 60UA, 60MA, and 60LA is selected. Then, a feeding motor 250A is driven to start feeding the sheet from the selected sheet feeding unit (S1-2).

Here, it is assumed that the controller 9 determines, for example, feeding of the sheet from the sheet feeding unit 60UA. Then, in the second registration unit 240A, the second pre-registration upper driving motor 251A is driven, the sheet is fed toward the second registration roller pair 243A by the second upper conveyance roller pair 245A, and the sheet arrives at the second registration roller pair 243A (S10-2). At this time, the leading edge of the sheet is detected by the second pre-registration sensor S1A.

The controller 9 calculates a second registration loop amount based on a timing at which the leading edge of the sheet is detected by the second pre-registration sensor S1A, and stops the second registration roller pair 243A such that the sheet buckles (forms a loop) by the second registration loop amount. Then, as indicated by an arrow b in FIG. 5, the lower guide 301aA pressed by a spring (not shown) pivots such that the guide is curved outward according to an increase in loop amount to form a loop space (see a sheet Sa). As a result, the leading edge of the sheet S that has entered while skewing at an angle θ1 follows the nip portion of the second registration roller pair 243A, so that skew is corrected (first skew correction) (S11-2).

Next, the controller 9 drives the second registration roller pair 243A at a timing when the sheet buckles by the second registration loop amount, and resumes the conveyance of the sheet. As a result, the sheet S subjected to the first skew correction is conveyed for a predetermined time by the second upper conveyance roller pair 245A and the second registration roller pair 243A. Thereafter, as indicated by an arrow a in FIG. 5, the nip of the second upper conveyance roller pair 245A is released by the second pre-registration upper separation driving motor 252A. When the leading edge of the sheet S is detected by the second pre-shift sensor S2A, the sheet S is stopped in front of the nip portion of the second shift roller pair 244A (see a sheet Sb) (S12-2).

Subsequently, the controller 9 resumes the conveyance of the sheet that has been stopped, according to an exposure timing of the exposure device 511. At this time, the position of the side edge (an edge portion in the width direction W) of the sheet is detected by the second line sensor S3A, that is, a lateral deviation amount is detected (calculated by the CPU 93) (S13-2). As illustrated in FIG. 5, the lateral deviation amount is a deviation amount Δ1 from a reference position 0 of the line sensor in the width direction W, which is determined for each sheet size, and the deviation amount Δ1 is set as a second lateral registration detection amount.

Next, when the leading edge of the sheet S is conveyed by the second shift roller pair 244A by a predetermined distance, the controller 9 releases the nip of the second registration roller pair 243A by the second registration separation driving motor 256A as indicated by an arrow c in FIG. 5 (see a sheet Sc) (S14-2).

Then, as indicated by an arrow d in FIG. 5, the controller 9 causes the second shift motor 259A to move the sheet S conveyed by the second shift roller pair 244A in the width direction W together with the second shift roller pair 244A by the second lateral registration detection amount (S15-2). As a result, a large positional deviation of the sheet in the width direction is corrected (first lateral registration correction). The first lateral registration correction refers to the first lateral registration correction performed on the sheet by the image forming system 1. At this time, the sheet may slightly turn due to an influence of a curved path of the upper conveyance path αA positioned upstream, and skewing at an angle θ2, which serves as skew reversion, may occur.

Next, the sheet conveyed to the merging conveyance path 110 of the image forming apparatus 1A is conveyed to the third registration unit 100. That is, the sheet is conveyed to the curved guide 120 which is a loop space by the second shift roller pair 244A and the third pre-registration roller pair 101, and reaches the third registration roller pair 102 (S16).

Then, the controller 9 stops the third registration roller pair 102, and forms a third registration loop in the curved guide 120 based on a timing when the leading edge of the sheet S is detected by the third pre-registration sensor S4 (see a sheet Sd) (S17). As a result, the leading edge of the sheet S that has entered while skewing at the angle θ2 follows the nip portion of the third registration roller pair 102, so that skew is corrected (second skew correction).

Next, the controller 9 detects the side edge of the sheet S by the third line sensor S5, that is, detects a lateral deviation amount (S18). As illustrated in FIG. 5, the lateral deviation amount is a deviation amount Δ2 from the reference position 0 of the line sensor in the width direction W, which is determined for each sheet size, and the deviation amount Δ2 is set as a third lateral registration detection amount.

Here, in the present embodiment, a method of the second lateral registration correction is different between a case where the sheet fed to the third registration unit 100 is the first sheet (the first sheet in the print job) and a case where the sheet fed to the third registration unit 100 is the second or subsequent sheet. A case where the fed sheet S is the first sheet (Y in S19) will be described. The second lateral registration correction refers to second lateral registration correction performed on the sheet by the image forming system 1.

First, in a case where the fed sheet S is the first sheet, the controller 9 continues to stop the third registration roller pair 102 while the leading edge of the sheet S abuts against the nip portion of the third registration roller pair 102 (see the sheet Sd) (S20).

Next, the controller 9 moves an exposure position of the exposure device 511 in the width direction W by the third lateral registration detection amount (deviation amount Δ2) and forms the image on the photosensitive drum 508 of each color. At this time, the reference position 0 of the third line sensor S5 in a case where the side edge of the second or subsequent sheet is detected by the third line sensor S5 is moved by the deviation amount Δ2 and newly changed to a reference position 0′.

Subsequently, the controller 9 drives the third registration roller pair 102 according to the exposure timing of the exposure device 511 to resume the conveyance of the sheet S that has been stopped after the third skew correction (S22-1).

Thereafter, the leading edge of the sheet is conveyed by a predetermined amount from the nip portion of the third registration roller pair 102. Then, as indicated by arrows e and f in FIG. 5, the controller 9 releases the nip of the second shift roller pair 244A and the nip of the third pre-registration roller pair 101 by driving the second shift separation driving motor 258A and the third pre-registration separation driving motor 152 (S23-1).

The post-registration sensor S6 that detects the leading edge of the sheet is disposed downstream of the third registration roller pair 102 in the sheet conveyance direction D. The controller 9 measures the delay time of the sheet based on the detection by the post-registration sensor S6, controls a speed of conveyance of the sheet S by the third registration roller pair 102 accordingly, and conveys the sheet such that the sheet reaches the secondary transfer portion in a state in which the delay time is canceled (S25).

Then, the sheet S is conveyed to the secondary transfer portion formed by the secondary transfer inner roller 503 and the secondary transfer roller 56, and the toner image whose position has been corrected by the third lateral registration detection amount (deviation amount Δ2) as described above is transferred to the sheet (see a sheet Se) (S26).

Thereafter, when the sheet is conveyed from the secondary transfer portion by a predetermined amount, the nip of the third registration roller pair 102 is released by the third registration separation driving motor 154 as indicated by an arrow h in FIG. 5 (S27).

Thereafter, the sheet is conveyed to the fixing device 58 by the pre-fixing conveyance unit 57 (see FIG. 1), and the toner image transferred to the sheet is fixed (S28). Then, for example, in the case of single-sided printing, the sheet on which the toner image has been fixed is discharged to the discharge tray 500 as it is (S29), and the conveyance control of the image forming system for one sheet ends. In the case of duplex printing, the processing returns to step S19, and control for the second and subsequent sheets described below is performed. In addition, for the second and subsequent sheets, the conveyance control of the image forming system illustrated in FIG. 4 is performed again, and the processing is repeated until the number of printed sheets reaches a number instructed in the print job, and when the number of printed sheets reaches the instructed number, preparation for the next print job is performed.

Next, a description will be given of a case where the sheet fed to the third registration unit 100 of the image forming apparatus 1A is the second or subsequent sheet. Control from step S0 to step S18 is similar to that in a case where the sheet is the first sheet, and thus the description thereof will be omitted.

In a case where the sheet fed to the third registration unit 100 is the second or subsequent sheet (N in S19), the third registration roller pair 102 is not stopped, and the sheet S subjected to the third skew correction is conveyed as it is by the third registration roller pair 102 (S22-2).

Therefore, the leading edge of the sheet is conveyed by a predetermined amount from the nip portion of the third registration roller pair 102. Then, as indicated by the arrows e and f in FIG. 5, the nip of the second shift roller pair 244A and the nip of the third pre-registration roller pair 101 are released by driving the second shift separation driving motor 258A and the third pre-registration separation driving motor 152 (S23-2).

Then, as indicated by the arrow g in FIG. 5, the sheet S conveyed by the third registration roller pair 102 is moved in the width direction W by the third shift motor 155 together with the third registration roller pair 102 by the third lateral registration detection amount (S24-2). As a result, a minute positional deviation of the sheet in the width direction is corrected (second lateral registration correction). In addition, the deviation amount Δ2 in this case is an extremely small deviation amount from the new reference position 0′ moved by the deviation amount of the first sheet defined in step S21. Therefore, the skew reversion associated with the third lateral registration correction does not occur.

Since subsequent steps S25 to S29 are controlled similarly to a case where the fed sheet is the first sheet, the description thereof will be omitted.

Sheet Feeding from Upstream Deck

Next, a case where the sheet is fed from the upstream deck 2B to the image forming unit 1B of the image forming apparatus 1A will be described with reference to FIG. 4 and 6.

As described above, the controller 9 determines the sheet S of the size and the type designated in the print job, and selects a sheet feeding unit that stores a sheet matching the determined sheet size and type from among the sheet feeding units of the image forming system 1. Here, it is assumed that the selected sheet feeding unit is one of the sheet feeding units 60UB, 60MB, and 60LB of the upstream deck 2B (Y in S0), and any one of the sheet feeding units 60UB, 60MB, and 60LB is selected. Then, a feeding motor 250B is driven to start feeding the sheet from the selected sheet feeding unit (S1-1).

Here, it is assumed that the controller 9 determines, for example, feeding of the sheet from the sheet feeding unit 60UB. Then, in the first registration unit 240B, the first pre-registration upper driving motor 251B is driven, the sheet is fed toward the first registration roller pair 243B by the first upper conveyance roller pair 245B, and the sheet arrives at the first registration roller pair 243B (S2). At this time, the leading edge of the sheet is detected by the first pre-registration sensor S1B.

The controller 9 calculates a first registration loop amount based on a timing at which the leading edge of the sheet is detected by the first pre-registration sensor S1B, and stops the first registration roller pair 243B such that the sheet buckles (forms a loop) by the first registration loop amount. Then, as indicated by an arrow b in FIG. 6, the lower guide 301aB pressed by a spring (not shown) pivots such that the guide is curved outward according to an increase in loop amount to form a loop space (see a sheet Sa). As a result, the leading edge of the sheet S that has entered while skewing at an angle θ1 follows the nip portion of the first registration roller pair 243B, so that skew is corrected (first skew correction) (S3). The first skew correction refers to the first of the skew corrections performed on the sheet in the image forming system 1.

Next, the controller 9 drives the first registration roller pair 243B at a timing when the sheet buckles by the first registration loop amount, and resumes the conveyance of the sheet. As a result, the sheet S subjected to the first skew correction is conveyed for a predetermined time by the first upper conveyance roller pair 245B and the first registration roller pair 243B. Thereafter, as indicated by an arrow a in FIG. 6, the nip of the first upper conveyance roller pair 245B is released by the first pre-registration upper separation driving motor 252B. When the leading edge of the sheet S is detected by the first pre-shift sensor S2B, the sheet S is stopped in front of the nip portion of the first shift roller pair 244B (see a sheet Sb) (S4).

Subsequently, the controller 9 resumes the conveyance of the sheet that has been stopped, according to the exposure timing of the exposure device 511. At this time, the position of the side edge (an edge portion in the width direction W) of the sheet is detected by the first line sensor S3B, that is, a lateral deviation amount is detected (calculated by the CPU 93) (S5). As illustrated in FIG. 6, the lateral deviation amount is a deviation amount Δ1 from the reference position 0 of the line sensor in the width direction W, which is determined for each sheet size, and the deviation amount Δ1 is set as a first lateral registration detection amount.

Next, when the leading edge of the sheet S is conveyed by the first shift roller pair 244B by a predetermined distance, the controller 9 releases the nip of the first registration roller pair 243B by the first registration separation driving motor 256B as indicated by an arrow c in FIG. 6 (see a sheet Sc) (S6).

Then, as indicated by an arrow d in FIG. 6, the controller 9 causes the first shift motor 259B to move the sheet S conveyed by the first shift roller pair 244B in the width direction W together with the first shift roller pair 244B by the second lateral registration detection amount (S7). As a result, a large positional deviation of the sheet in the width direction is corrected (first lateral registration correction). At this time, the sheet may slightly turn due to an influence of a curved path of the upper conveyance path αB positioned upstream, and skew reversion may occur.

Next, the sheet conveyed to the receiving conveyance path 470 of the downstream deck 2A is conveyed by the relay conveyance device 400 (S9). Specifically, when the sheet S delivered to the inlet roller pair 401 is conveyed by a predetermined amount, the nip of the first shift roller pair 244B is released by the first shift separation driving motor 258B as indicated by an arrow e in FIG. 6 (S8). Then, the sheet S delivered to the inlet roller pair 401 is conveyed to the conveyance path 215 which is a part of the conveyance path PS by the conveyor belt 412, the pre-outlet roller pair 402, and the outlet roller pair 403. In the present embodiment, skew correction and lateral registration correction are performed on the sheet S in the upstream deck 2B. Therefore, it is not necessary to perform correction in the positional deviation correction unit 410, that is, it is not necessary to guide the side edge of the sheet S by actively regulating the side edge by the first regulating guide 414A and the second regulating guide 414B.

Thereafter, the sheet S conveyed by the relay conveyance device 400 reaches the second registration roller pair 243A of the second registration unit 240A (S10-1). Here, since the skew correction and the lateral registration correction have already been performed by the first registration unit 240B of the upstream deck 2B, the skew correction and the lateral registration correction are not performed.

Subsequently, the sheet S conveyed by the pre-outlet roller pair 402, the outlet roller pair 403, and the second registration roller pair 243A is conveyed so as to arrive at the second shift roller pair 244A (S12-1).

Then, when the leading edge of the sheet is conveyed by a predetermined amount from the nip portion of the second shift roller pair 244A, the nip of the pre-outlet roller pair 402 is released (separated) by the first relay outlet separation driving motor 487 as indicated by an arrow i in FIG. 6. Further, as indicated by an arrow j in FIG. 6, the nip of the outlet roller pair 403 is released (separated) by the second relay outlet separation driving motor 488. Further, as indicated by an arrow c in FIG. 6, the nip of the second registration roller pair 243A is released (separated) by the second registration separation driving motor 256A (S14-1). Then, the sheet S is conveyed to the third registration unit 100 of the image forming apparatus 1A by the second shift roller pair 244A. At this time, the sheet S conveyed by the relay conveyance device 400 and the plurality of roller pairs of the second registration unit 240A is slightly skewed at an angle θ2 as illustrated in FIG. 6.

The sheet conveyed to the third registration unit 100 is conveyed to the curved guide 120 which is a loop space by the second shift roller pair 244A and the third pre-registration roller pair 101, and reaches the third registration roller pair 102 (S16).

Then, the controller 9 stops the third registration roller pair 102, and forms the third registration loop in the curved guide 120 based on a timing when the leading edge of the sheet S is detected by the third pre-registration sensor S4 (see a sheet Sd) (S17). As a result, the leading edge of the sheet S that has entered while skewing at the angle θ2 follows the nip portion of the third registration roller pair 102, so that skew is corrected (second skew correction). The second skew correction refers to the second of the skew corrections performed on the sheet in the image forming system 1.

Next, the controller 9 detects the side edge of the sheet S by the third line sensor S5, that is, detects a lateral deviation amount (S18). As illustrated in FIG. 6, the lateral deviation amount is a deviation amount Δ2 from the reference position 0 of the line sensor in the width direction W, which is determined for each sheet size, and the deviation amount Δ2 is set as a third lateral registration detection amount.

Thereafter, as described above, different second lateral registration corrections are performed in a case where the sheet fed to the third registration unit 100 is the first sheet and a case where the sheet is the second or subsequent sheet. However, since such a difference is similar to a case where the sheet is fed from the downstream deck 2A, the description thereof will be omitted.

In the sheet conveyance control described above, the sheet is fed from the upper sheet feeding unit 60UA of the downstream deck 2A or the upper sheet feeding unit 60UB of the upstream deck 2B. However, the same applies to a case where the sheet is fed from the middle sheet feeding unit 60MA or the middle sheet feeding unit 60MB. In addition, in a case where the sheet is fed from the lower sheet feeding unit 60LA or the lower sheet feeding unit 60LB, the sheet passes through the lower conveyance path βA or the lower conveyance path βB instead of passing through the upper conveyance path αA or the upper conveyance path αB, and the first skew correction is performed there. However, other controls are the same.

In addition, in a case where the sheet is fed from the sheet feeding unit 50 of the image forming apparatus 1A, control from step S19 to step S29 is performed. In this case, although the skew correction and the lateral registration correction are performed only once, a conveyance distance from the sheet feeding unit to the secondary transfer portion is short, and thus, there is no major problem.

For the sheet conveyance control according to the first embodiment described above, a configuration in which the first skew correction and the first lateral registration correction are performed by the first registration unit 240B in a case where the sheet is fed from the sheet feeding unit of the upstream deck 2B has been described. Further, a configuration in which the third registration unit 100 performs the second skew correction and the second lateral registration correction, and a configuration in which the second lateral registration correction is performed at a position where the toner image is formed in the image forming unit 1B in a case where the fed sheet is the first sheet have been described. In short, a configuration in which the skew correction and the lateral registration correction are not performed in the second registration unit 240A and the relay conveyance device 400 has been described.

However, the present technology is not limited thereto, and it is sufficient if the sheet can be conveyed to the image forming apparatus 1A after the first skew correction and the first lateral registration correction are performed at any position in the image forming system 1. That is, if the sheet conveyed to the image forming apparatus 1A is not greatly laterally deviated or skewed, the lateral deviation or skew of the sheet can be corrected only by performing the second skew correction and the second lateral registration correction in the image forming apparatus 1A, and proper alignment for image formation can be achieved. Accordingly, it is sufficient if the first skew correction and the first lateral registration correction for correcting great lateral deviation and skew of the sheet before the sheet is conveyed to the image forming apparatus 1A are performed at any position. Therefore, for example, in a case where the sheet is fed from the sheet feeding unit of the upstream deck 2B, it is conceivable that the first skew correction and the first lateral registration correction are performed by the positional deviation correction unit 410 of the relay conveyance device 400. In this case, it can be said that the positional deviation correction unit 410 functions as the second correction unit. In addition, in a case where the positional deviation correction unit 410 performs the first lateral registration correction, the sheet is aligned with the conveyance center (the center of the conveyance path PS in the width direction in design) by the first regulating guide 414A and the second regulating guide 414B, and thus, it is not necessary to detect the position of the sheet in the width direction by using the line sensor or the like. Furthermore, for example, in a case where the sheet is fed from the sheet feeding unit of the upstream deck 2B, it is conceivable that the first skew correction and the first lateral registration correction are performed by the second registration unit 240A.

### Summary of First Embodiment

As described above, in the image forming system 1 according to the first embodiment, the controller 9 corrects a widthwise position of the sheet conveyed from the sheet feeding unit 60UA, 60MA, or 60LA of the upstream deck 2B to the conveyance path PS by any one of the first registration unit 240B (or the positional deviation correction unit 410) and the second registration unit 240A (the first lateral registration correction is performed). The corrected sheet is fed to the image forming apparatus 1A. In particular, in the present embodiment, the widthwise position of the sheet conveyed from the sheet feeding unit 60UA, 60MA, or 60LA of the upstream deck 2B to the conveyance path PS is corrected by the first registration unit 240B, and the widthwise position of the sheet is not corrected by the positional deviation correction unit 410 and the second registration unit 240A. Alternatively, in a case where the widthwise position of the sheet conveyed from the sheet feeding unit 60UA, 60MA, or 60LA of the upstream deck 2B to the conveyance path PS is corrected by the positional deviation correction unit 410, the widthwise position of the sheet is not corrected by the first registration unit 240B and the second registration unit 240A. Alternatively, in a case where the widthwise position of the sheet conveyed from the sheet feeding unit 60UA, 60MA, or 60LA of the upstream deck 2B to the conveyance path PS is corrected by the second registration unit 240A, the widthwise position of the sheet is not corrected by the first registration unit 240B and the positional deviation correction unit 410.

Further, in the image forming system 1 according to the first embodiment, the controller 9 corrects skew of the sheet conveyed from the sheet feeding unit 60UA, 60MA, or 60LA of the upstream deck 2B to the conveyance path PS by any one of the first registration unit 240B (or the positional deviation correction unit 410) and the second registration unit 240A (the first skew correction is performed). In particular, in the present embodiment, the skew of the sheet conveyed from the sheet feeding unit 60UA, 60MA, or 60LA of the upstream deck 2B to the conveyance path PS is corrected by the first registration unit 240B, and the skew of the sheet is not corrected by the positional deviation correction unit 410 and the second registration unit 240A. Alternatively, in a case where the skew of the sheet conveyed from the sheet feeding unit 60UA, 60MA, or 60LA of the upstream deck 2B to the conveyance path PS is corrected by the positional deviation correction unit 410, the skew of the sheet is not corrected by the first registration unit 240B and the second registration unit 240A. Alternatively, in a case where the skew of the sheet conveyed from the sheet feeding unit 60UA, 60MA, or 60LA of the upstream deck 2B to the conveyance path PS is corrected by the second registration unit 240A, the skew of the sheet is not corrected by the first registration unit 240B and the positional deviation correction unit 410.

As a result, in a configuration in which a plurality of apparatuses are coupled as in the image forming system 1, it is possible to suppress an increase in the number of executions of the correction processing and suppress decrease in productivity. In particular, in a case where a plurality of sheet feeding apparatuses are coupled to the image forming apparatus 1A, the conveyance path PS becomes long. However, even in such a case, the number of executions of skew correction or lateral registration correction can be reduced, so that decrease in productivity can be suppressed.

### Second Embodiment

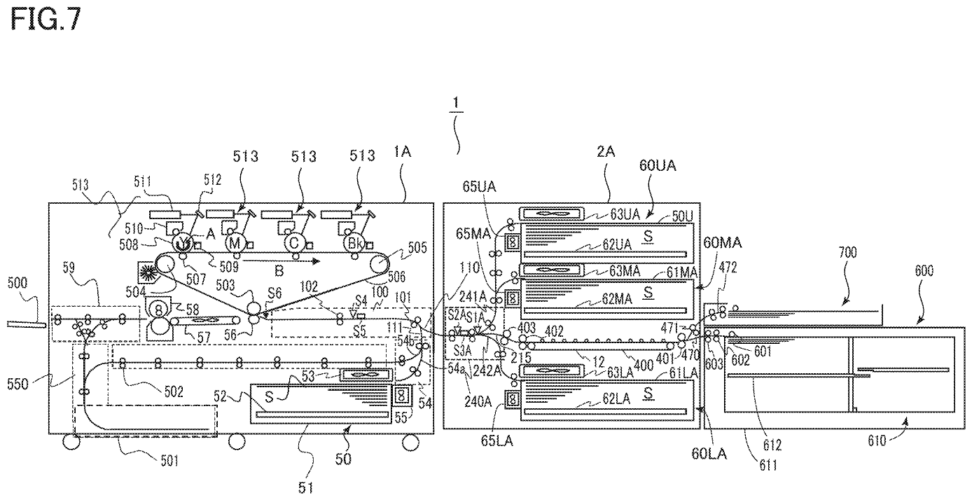

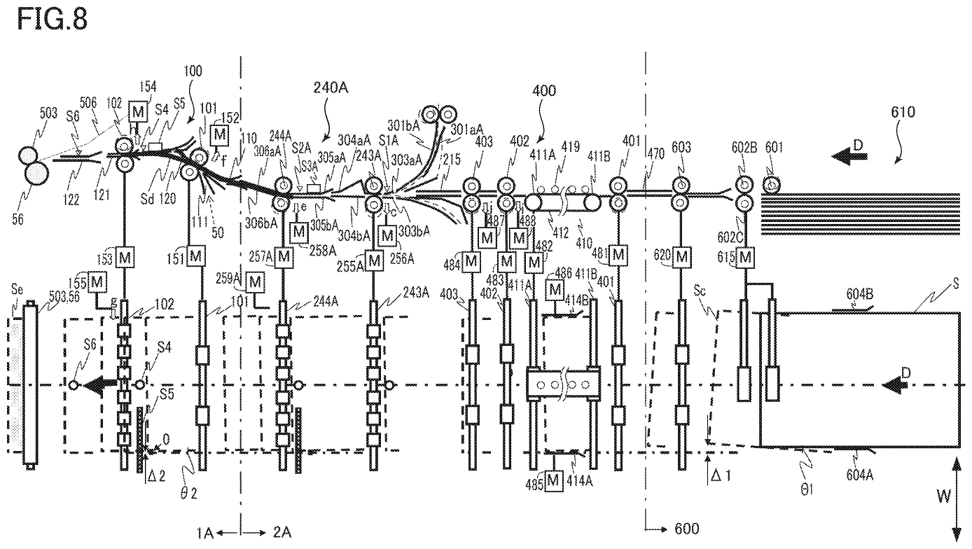

Next, a second embodiment partially modified from the first embodiment will be described with reference to FIGS. 7 and 8. FIG. 7 is a schematic view illustrating an image forming system according to the second embodiment. FIG. 8 is a schematic view illustrating configurations of a first registration unit, a first sheet feeding apparatus, a long-sheet feeding apparatus, and a manual feeding apparatus according to the second embodiment. In the description of the second embodiment, the same reference numerals are used for the same parts as those of the first embodiment, and a description thereof will be omitted.

In the second embodiment, unlike the first embodiment, a long-sheet feeding apparatus 600 and a manual feeding apparatus 700 are coupled to a downstream deck 2A, instead of an upstream deck 2B. In a case where a sheet is fed from the long-sheet feeding apparatus 600 or the manual feeding apparatus 700 to the downstream deck 2A, first skew correction and first lateral registration correction are performed by a relay conveyance device 400.

Specifically, as illustrated in FIGS. 7 and 8, the long-sheet feeding apparatus 600 includes a sheet feeding unit 610 serving as a second feeding unit, and the sheet feeding unit 610 includes a storage 611, a lift plate 612 that supports the sheet, and side regulating plates 604A and 604B. In the storage 611, a long sheet can be supported on the lift plate 612, and the sheet is set in a state in which a position of the sheet in a width direction is regulated by the side regulating plates 604A and 604B.

The sheet feeding unit 610 is configured to feed the sheet by a so-called retard feeding method, and includes a feeding roller 601 and a separation roller pair 602, which are driven by a feeding driving motor 615, and a drawing roller pair 603 driven by a drawing driving motor 620. The separation roller pair 602 includes a conveyance roller 602B and a separation roller 602C, and separates and conveys the sheets one by one. The sheets separated one by one are conveyed to a receiving conveyance path 470 of the downstream deck 2A, which is an apparatus positioned downstream, by the drawing roller pair 603.

In addition, the manual feeding apparatus 700 is installed and supported on the long-sheet feeding apparatus 600. The sheet fed from the manual feeding apparatus 700 is fed from a manual feeding conveyance path 472 to the receiving conveyance path 471 of the downstream deck 2A, merges into the receiving conveyance path 470, that is, merges into a conveyance path PS, and is fed along the conveyance path PS. Operations of the first skew correction and the first lateral registration correction on the sheet fed from the manual feeding apparatus 700 to the downstream deck 2A are the same as those in a case where the sheet is fed from the long-sheet feeding apparatus 600. Therefore, in the following description, sheet feeding from the long-sheet feeding apparatus 600 will be described, and the description of sheet feeding from the manual feeding apparatus 700 will be omitted.

As illustrated in FIG. 8, in the sheet feeding unit 610, feeding is started by the feeding roller 601, and a sheet Sc separated one by one by the separation roller pair 602 may be skewed at an angle θ1 or deviate from a reference position by a deviation amount Δ1 in a width direction W. When such a sheet is delivered to an inlet roller pair 401 of the relay conveyance device 400, the sheet is aligned with the conveyance center by a first regulating guide 414A and a second regulating guide 414B in a positional deviation correction unit 410. As a result, the skew of the sheet is corrected, and the position of the sheet in the width direction W is also corrected, that is, the first skew correction and the first lateral registration correction are performed. The position of the sheet in the width direction W aligned by the first regulating guide 414A and the second regulating guide 414B may be changed according to a reference position 0′ and the like described above.

The sheet subjected to the first skew correction and the first lateral registration correction in this manner is conveyed to a conveyance path 215 by a pre-outlet roller pair 402 and an outlet roller pair 403, and conveyed to a second registration unit 240A of the downstream deck 2A. However, since the lateral registration correction and the skew correction have already been performed by the positional deviation correction unit 410, the sheet conveyed from the long-sheet feeding apparatus 600 to the second registration unit 240A is not corrected here.

As illustrated in FIG. 8, a sheet S conveyed by the relay conveyance device 400 and the plurality of roller pairs of the second registration unit 240A remains skewed at an angle θ2. However, thereafter, the sheet conveyed to the image forming apparatus 1A is conveyed to a secondary transfer portion after second skew correction and second lateral registration correction are performed in a third registration unit 100, and a toner image is transferred. Alternatively, in an image forming unit 1B, a position where the toner image is formed in the width direction W may be corrected (second lateral registration correction). Then, the toner image of the sheet is fixed by a fixing device 58, and the sheet is discharged onto a discharge tray 500.

Also in the second embodiment described above, a configuration in which the first skew correction and the first lateral registration correction are performed by the positional deviation correction unit 410 of the relay conveyance device 400 in a case where the sheet is fed from the sheet feeding unit of the long-sheet feeding apparatus 600 has been described. Further, a configuration in which the third registration unit 100 performs the second skew correction and the second lateral registration correction, and a configuration in which the second lateral registration correction is performed at a position where the toner image is formed in the image forming unit 1B in a case where the fed sheet is the first sheet have been described. In short, a configuration in which the skew correction and the lateral registration correction are not performed in the second registration unit 240A has been described.

However, the present technology is not limited thereto, and it is sufficient if the sheet can be conveyed to the image forming apparatus 1A after the first skew correction and the first lateral registration correction are performed at any position in the image forming system 1. That is, if the sheet conveyed to the image forming apparatus 1A is not greatly laterally deviated or skewed, the lateral deviation or skew of the sheet can be corrected only by performing the second skew correction and the second lateral registration correction in the image forming apparatus 1A, and proper alignment for image formation can be achieved. Accordingly, it is sufficient if the first skew correction and the first lateral registration correction for correcting great lateral deviation and skew of the sheet before the sheet is conveyed to the image forming apparatus 1A are performed at any position. Therefore, for example, in a case where the sheet is fed from the sheet feeding unit 610 of the long-sheet feeding apparatus 600, it is conceivable that the first skew correction and the first lateral registration correction are performed by the second registration unit 240A.

As described above, also in the image forming system 1 according to the second embodiment, the controller 9 corrects a widthwise position of the sheet conveyed from the sheet feeding unit 610 of the long-sheet feeding apparatus 600 to the conveyance path PS by any one of the positional deviation correction unit 410 and the second registration unit 240A (the first lateral registration correction is performed). In particular, in the present embodiment, the widthwise position of the sheet conveyed from the sheet feeding unit 610 of the long-sheet feeding apparatus 600 to the conveyance path PS is corrected by the positional deviation correction unit 410 of the relay conveyance device 400, and the widthwise position of the sheet is not corrected by the second registration unit 240A. Alternatively, in a case where the widthwise position of the sheet conveyed from the sheet feeding unit 610 of the long-sheet feeding apparatus 600 to the conveyance path PS is corrected by the second registration unit 240A, the widthwise position of the sheet is not corrected by the positional deviation correction unit 410 of the relay conveyance device 400.

Further, also in the image forming system 1 according to the second embodiment, the controller 9 corrects the skew of the sheet conveyed from the sheet feeding unit 610 of the long-sheet feeding apparatus 600 to the conveyance path PS by any one of the positional deviation correction unit 410 and the second registration unit 240A (the first skew correction is performed). In particular, in the present embodiment, the skew of the sheet conveyed from the sheet feeding unit 610 of the long-sheet feeding apparatus 600 to the conveyance path PS is corrected by the positional deviation correction unit 410 of the relay conveyance device 400, and the skew of the sheet is not corrected by the second registration unit 240A. Alternatively, in a case where the skew of the sheet conveyed from the sheet feeding unit 610 of the long-sheet feeding apparatus 600 to the conveyance path PS is corrected by the second registration unit 240A, the skew of the sheet is not corrected by the positional deviation correction unit 410 of the relay conveyance device 400.

As a result, in a configuration in which a plurality of apparatuses are coupled as in the image forming system 1, it is possible to suppress an increase in the number of executions of the correction processing and suppress decrease in productivity. In particular, in a case where a plurality of sheet feeding apparatuses are coupled to the image forming apparatus 1A, the conveyance path PS becomes long. However, even in such a case, the number of executions of skew correction or lateral registration correction can be reduced, so that decrease in productivity can be suppressed. Although a case where the sheet is fed from the sheet feeding unit 610 of the long-sheet feeding apparatus 600 to the conveyance path PS has been described here, the same effect can be obtained by performing similar control in a case where the sheet is fed from the manual feeding apparatus 700.

### Possibility of Other Embodiments

In the first and second embodiments described above, a configuration in which the downstream deck 2A and the upstream deck 2B are coupled to the image forming apparatus 1A, or the downstream deck 2A and the long-sheet feeding apparatus 600 are coupled to the image forming apparatus 1A has been described. That is, a configuration in which two apparatuses are coupled to the image forming apparatus 1A at positions upstream in the sheet conveyance direction has been described. However, the present technology is not limited thereto, and the number of coupled apparatuses may be three or more. That is, the image forming system may have any configuration as long as the image forming system includes at least two feeding units configured to feed a sheet and at least two correction units capable of performing width-direction correction and/or skew correction on the sheet.

In the first and second embodiments, a configuration in which no apparatus positioned downstream in the sheet conveyance direction is coupled to the image forming apparatus 1A has been described, but the present technology is not limited thereto. For example, one or more processing apparatuses that perform stapling, punching, binding, and inspection may be coupled to the image forming apparatus 1A at positions downstream of the image forming apparatus 1A in the sheet conveyance direction.

In the first and second embodiments, a configuration in which the first lateral registration correction, the first skew correction, the second lateral registration correction, and the second skew correction are performed on the conveyed sheet in the image forming system 1 has been described. However, the present technology is not limited thereto, and it is sufficient if the lateral registration correction is performed at least twice [2] on the sheet. That is, the skew correction may be performed only once, or may be omitted.

In the first and second embodiments, basically, a configuration in which the first lateral registration correction, the first skew correction, the second lateral registration correction, and the second skew correction are performed on the sheet by different apparatuses (the upstream deck 2B and the downstream deck 2A, or the long-sheet feeding apparatus 600 and the downstream deck 2A) has been described. However, a configuration in which the first lateral registration correction, the first skew correction, the second lateral registration correction, and the second skew correction are performed on the sheet by the second registration unit 240A and the relay conveyance device 400 has also been described. That is, one sheet feeding apparatus may perform the first lateral registration correction and the second lateral registration correction on the sheet, and one sheet feeding apparatus may perform the first lateral registration correction, the first skew correction, the second lateral registration correction, and the second skew correction on the sheet.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-081045, filed May 14, 2025 which is hereby incorporated by reference herein in its entirety.

What is claimed is:

1. An image forming system comprising:
an image forming apparatus including an image forming unit configured to form an image on a sheet;
a first sheet feeding apparatus coupled to the image forming apparatus at a position upstream of the image forming apparatus in a sheet conveyance direction and including a first feeding unit configured to feed the sheet, a first conveyance path through which the sheet fed from the first feeding unit is conveyed toward the image forming apparatus, and a third conveyance path connected to the first conveyance path;
a second sheet feeding apparatus coupled to the first sheet feeding apparatus at a position upstream of the first sheet feeding apparatus in the sheet conveyance direction and including a second feeding unit configured to feed the sheet and a second conveyance path through which the sheet fed from the second feeding unit is conveyed toward the third conveyance path;
a first correction unit disposed on the first conveyance path and configured to correct a widthwise position of the sheet by moving the sheet in a width direction orthogonal to the sheet conveyance direction;
a second correction unit disposed upstream of the first conveyance path and downstream of the second feeding unit and configured to correct the widthwise position of the sheet by moving the sheet in the width direction; and
a control unit configured to correct the widthwise position of the sheet fed from the second feeding unit by one of the first correction unit and the second correction unit and feed the corrected sheet to the image forming apparatus.

2. The image forming system according to claim 1, wherein the control unit is configured to correct the widthwise position of the sheet fed from the second feeding unit by the second correction unit, and does not correct the widthwise position of the sheet fed from the second feeding unit by the first correction unit.

3. The image forming system according to claim 1, wherein the first correction unit includes a first conveyance roller pair configured to nip and convey the sheet, and a first movement driving unit configured to move the first conveyance roller pair in the width direction.

4. The image forming system according to claim 3, wherein the control unit is configured to perform skew correction of the sheet by causing a leading edge of the sheet conveyed to the first conveyance roller pair to abut against the first conveyance roller pair in a stopped state and buckle, and then drive the first conveyance roller pair to convey the sheet.

5. The image forming system according to claim 3, wherein
the first correction unit includes a first widthwise position detection unit configured to detect a position of the sheet in the width direction at a first detection position upstream of the first conveyance roller pair in the sheet conveyance direction, and
the control unit is configured to control the first movement driving unit based on a detection result of the first widthwise position detection unit to correct the widthwise position of the sheet.

6. The image forming system according to claim 3, wherein
the first correction unit includes a second conveyance roller pair configured to convey the sheet, and a first curved guide portion forming a first curved conveyance path configured to cause the sheet fed from the first feeding unit to merge at a position upstream of the second conveyance roller pair in the sheet conveyance direction, the first curved conveyance path being curved as viewed from the width direction, and
the control unit is configured to perform skew correction of the sheet by causing a leading edge of the sheet conveyed on the first curved conveyance path to abut against the second conveyance roller pair in a stopped state and buckle, and then drive the second conveyance roller pair to convey the sheet to the first conveyance roller pair.

7. The image forming system according to claim 1, wherein the second correction unit includes a third conveyance roller pair configured to nip and convey the sheet, and a second movement driving unit configured to move the third conveyance roller pair in the width direction.

8. The image forming system according to claim 7, wherein the control unit is configured to perform skew correction of the sheet by causing a leading edge of the sheet conveyed to the third conveyance roller pair to abut against the third conveyance roller pair in a stopped state and buckle, and then drive the third conveyance roller pair to convey the sheet.

9. The image forming system according to claim 7, wherein
the second correction unit includes a second widthwise position detection unit configured to detect a position of the sheet in the width direction at a second detection position upstream of the third conveyance roller pair in the sheet conveyance direction, and
the control unit is configured to control the second movement driving unit based on a detection result of the second widthwise position detection unit to correct the widthwise position of the sheet.

10. The image forming system according to claim 7, wherein
the second correction unit includes a fourth conveyance roller pair configured to convey the sheet, and a second curved guide portion forming a second curved conveyance path configured to cause the sheet fed from the second feeding unit to merge at a position upstream of the fourth conveyance roller pair in the sheet conveyance direction, the second curved conveyance path being curved as viewed from the width direction, and
the control unit is configured to perform skew correction of the sheet by causing a leading edge of the sheet conveyed on the second curved conveyance path to abut against the fourth conveyance roller pair in a stopped state and buckle, and then drive the fourth conveyance roller pair to convey the sheet to the third conveyance roller pair.

11. The image forming system according to claim 1, wherein the second correction unit includes a belt configured to convey the sheet, a sphere disposed to face the belt and configured to rotate in an arbitrary direction, a first regulating guide and a second regulating guide respectively disposed on both sides of the belt in the width direction and configured to abut on side edges of the sheet nipped between the belt and the sphere, and a third movement driving unit configured to move the first regulating guide and the second regulating guide in the width direction.

12. The image forming system according to claim 1, wherein
the first correction unit is disposed in the first sheet feeding apparatus,
the second correction unit is disposed in the second sheet feeding apparatus, and
the image forming apparatus is configured to form the image on the sheet discharged from the first sheet feeding apparatus by using the image forming unit.

13. The image forming system according to claim 12, wherein the image forming apparatus includes a third correction unit configured to correct the widthwise position of the sheet by moving the sheet conveyed from the first sheet feeding apparatus in the width direction.

14. The image forming system according to claim 12, wherein the image forming unit is configured to correct a position of the image to be formed on the sheet in the width direction.

15. The image forming system according to claim 12, wherein the second correction unit is disposed on the second conveyance path.

16. The image forming system according to claim 1, wherein
the first correction unit and the second correction unit are disposed in the first sheet feeding apparatus, and
the image forming apparatus is configured to form the image on the sheet discharged from the first sheet feeding apparatus by using the image forming unit configured to form the image on the sheet.

17. The image forming system according to claim 16, wherein the image forming apparatus includes a third correction unit configured to correct the widthwise position of the sheet by moving the sheet conveyed from the first sheet feeding apparatus in the width direction.

18. The image forming system according to claim 16, wherein the image forming unit is configured to correct a position of the image to be formed on the sheet in the width direction.

19. A sheet feeding apparatus including a first sheet feeding apparatus and a second sheet feeding apparatus that is coupled to the first sheet feeding apparatus at a position upstream of the first sheet feeding apparatus in a sheet conveyance direction, the sheet feeding apparatus comprising:
a first feeding unit disposed in the first sheet feeding apparatus and configured to feed a sheet toward a first conveyance path;
a second feeding unit disposed in the second sheet feeding apparatus and configured to feed the sheet toward a second conveyance path;
a first correction unit disposed on the first conveyance path and configured to correct a widthwise position of the sheet by moving the sheet in a width direction orthogonal to the sheet conveyance direction;
a second correction unit disposed upstream of the first conveyance path and downstream of the second feeding unit and configured to correct the widthwise position of the sheet by moving the sheet in the width direction; and
a control unit configured to correct, by the first correction unit or the second correction unit, the widthwise position of the sheet conveyed from a position upstream of the second correction unit in the sheet conveyance direction.
